(19) United States
(12) Patent Application Publication
(10) Pub. No.: US 2025/0226667 A1
(43) Pub. Date: Jul. 10, 2025

(54) DISCRETE-TIME LOAD FREQUENCY CONTROLLER FOR HYBRID RENEWABLE POWER SYSTEM

(71) Applicant: KING FAHD UNIVERSITY OF PETROLEUM AND MINERALS, Dhahran (SA)

(72) Inventors: Muhammad Majid GULZAR, Dhahran (SA); Muhammad KHALID, Dhahran (SA)

(73) Assignee: KING FAHD UNIVERSITY OF PETROLEUM AND MINERALS, Dhahran (SA)

(21) Appl. No.: 18/409,318

(22) Filed: Jan. 10, 2024

(51) Int. Cl. H02J 3/38; H02J 3/24

(52) U.S. Cl. CPC H02J 3/381; H02J 3/24; H02J 2300/24; H02J 2300/28

(57) ABSTRACT

A distributed control system coupled to a hybrid renewable power system including an AC power section, a DC power section, and a primary load. The distributed control system includes current-controlled inverter to control flow of power between the DC power section and the AC power section using a pair of power flow control signals. The current-controlled inverter includes a proportional-integral controller to generate the pair of power flow control signals. The distributed control system includes a discrete frequency controller to perform a load frequency control of the hybrid renewable power system using a pair of load frequency control signals. The load frequency control controls frequency oscillations of the primary load. The discrete frequency controller is a discrete-time fuzzy tuned fractional-order proportional derivative controller that generates pair of load frequency control signals based on primary load frequency, desired load frequency, and rate of change of the primary load frequency.

### STATEMENT OF PRIOR DISCLOSURE BY AN INVENTOR

Aspects of the present disclosure were described in “Discrete-Time Modeling and Control for LFC Based on Fuzzy Tuned Fractional-Order PD^{μ} Controller in a Sustainable Hybrid Power System” Muhammad Majid Gulzar, Sumbal Gardezi, Daud Sibtain, Muhammad Khalid, IEEE Access, Volume 11, 63271-63287, which is incorporated herein by reference in its entirety.

### STATEMENT OF ACKNOWLEDGEMENT

The support provided by the Center of Renewable Energy and Power Systems at King Fahd University of Petroleum and Minerals (KFUPM) under Project No. INRE2106 and SDAIA-KFUPM Joint Research Center for Artificial Intelligence (JRC-AI) is gratefully acknowledged.

### TECHNICAL FIELD

The present disclosure is directed to a control system, device, and method, for a hybrid renewable power system, more particularly, a current controlled inverter and a discrete-time fuzzy tuned fractional-order proportional derivative controller for load frequency control (LFC) of the hybrid renewable power system.

### DESCRIPTION OF RELATED ART

The “background” description provided herein is for the purpose of generally presenting the context of the disclosure. Work of the presently named inventors, to the extent it is described in this background section, as well as aspects of the description which, may not otherwise qualify as prior art at the time of filing, are neither expressly or impliedly admitted as prior art against the present disclosure.

With climate change and the depletion of non-renewable energy resources, the shift towards more sustainable and environment friendly energy solutions has become essential. Currently, approximately 70% of global energy production is derived from non-renewable sources. The energy generation process utilizes such non-renewable sources as fuel to produce electrical energy, which is characterized by the emission of harmful gases such as carbon dioxide (CO₂) and carbon monoxide (CO). The emission of harmful gases leads to environmental challenges, including global warming. Adding to the environmental challenges, the dependence on finite sources like oil and gas as primary fuel sources is concerning, given the rapid depletion of existing reserves and the decreased discovery of new reserves. The reserves take near a million years to form, and in contrast, consumption will deplete the resources within just a few hundred years.

Therefore, the transition to cleaner, renewable energy (RE) sources like solar, tidal, wind, and biomass is gaining prominence. RE sources offer an eco-friendly alternative that is naturally available in abundance, and is sustainable and constantly replenished. One significant challenge within renewable energy systems is the establishment of an efficient interconnection network capable of accommodating fluctuating load demands. Load variations often induce frequency fluctuations in the power systems, leading to a challenge of frequency oscillation. Therefore, effective load frequency control is required to ensure system stability and optimal performance of a power system.

Generally, there are four distinct controllers available, namely classical proportional derivative (PD), self-adjusting fractional proportional derivative (F-PD), fractional-order proportional derivative (FOPD^{μ}), and fuzzy tuned fractional-order proportional derivative (F-FOPD^{μ}). While classical PD controllers are simplistic and convenient for modeling, they lack the robustness and automatic gain tuning attributes inherent in the F-PD controllers. However, out of the four controllers, the F-FOPD^{μ} is generally identified as the most proficient controller, especially with respect to stability assessments in dynamic conditions. The F-FOPD^{μ}, enriched with a broader array of control parameters and fractional-order derivatives, enables rapid post-disturbance system stabilization. Additionally, fuzzy rules integrated within F-FOPD^{μ} facilitate swift automatic adjustments of gains in response to any system variations, marking an improvement over the FOPD^{μ}. Despite the acknowledged effectiveness of fuzzy logic in gain scheduling for various controllers, its integration in hybrid systems comprising multiple resources is often hampered by complexity and cost. This limitation restricts its applicability in remote areas that prioritize cost-effectiveness and maintenance convenience.

Distributed control systems are currently integrated with standalone hybrid power systems, particularly in hybrid power systems with excess power being channeled to a secondary load. Distributed controls have been also been identified as a viable solution for cost optimization and efficiency. However, the dynamic nature of load conditions and renewable energy outputs necessitates more adaptable control schemes.

Accordingly, a need exists for a controller that is cost-effective, less complex, low maintenance and more adaptable to dynamic and variable conditions to reduce the frequency fluctuations attributable to disturbances within hybrid renewable power systems. The embodiments herein are directed to such a need. Various objectives of the embodiments herein include reducing frequency fluctuations caused by disturbances in hybrid power systems, integrating a discrete-time fractional fuzzy proportional-derivative controller for an enhanced load frequency control performance, more particularly, developing an efficient discrete frequency control system that functions as both a secondary load controller and provides load frequency control.

### SUMMARY

In an embodiment, a distributed control system coupled to a hybrid renewable power system is disclosed. The hybrid renewable power system includes an AC power section, a DC power section, and a primary load. The distributed control system comprises a current-controlled inverter configured to control a flow of power between the DC power section and the AC power section using a pair of power flow control signals. The current-controlled inverter comprises a proportional-integral controller configured to generate the pair of power flow control signals. The distributed control system further comprises a discrete frequency controller configured to perform a load frequency control of the hybrid renewable power system using a pair of load frequency control signals. The load frequency control is controlling one or more frequency oscillations of the primary load. The discrete frequency controller is a discrete-time fuzzy tuned fractional-order proportional derivative controller. The fuzzy tuned fractional-order proportional derivative controller is configured to generate the pair of load frequency control signals based on a primary load frequency, a desired load frequency, and a rate of change of the primary load frequency.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a schematic diagram of a hybrid renewable power system, according to certain embodiments;

FIG. 2 illustrates a block diagram of a secondary load, according to certain embodiments;

FIG. 3 illustrates a simulink diagram of the hybrid renewable power system, according to certain embodiments;

FIG. 4 illustrates a simulink model of a current-controlled inverter, according to certain embodiments;

FIG. 5 illustrates a fractional PI^{λ}D^{μ} controller graph, according to certain embodiments;

FIG. 6 illustrates a schematic diagram of a fuzzy tuned fractional-order proportional derivative (F-FOPD^{μ}) controller, according to certain embodiments;

FIG. 7 shows a Simulink mode of a discrete frequency regulator, according to certain embodiments;

FIG. 8 shows a Simulink model of the F-FOPD^{μ} controller, according to certain embodiments;

FIG. 9 shows a schematic of the F-FOPD^{μ} controller, according to certain embodiments;

FIG. 10A illustrates membership functions for input “error”, according to certain embodiments;

FIG. 10B illustrates membership functions for input “change in error”, according to certain embodiments;

FIG. 11A illustrates membership functions for output “ΔK_{P}”, according to certain embodiments;

FIG. 11B illustrates membership functions for output “ΔK_{D}”, according to certain embodiments;

FIG. 12A illustrates frequency responses of a classical proportional derivative (PD) controller′ with 50 KW load increment, according to certain embodiments;

FIG. 12B illustrate frequency responses of a fuzzy tuned proportional derivative (FOPD^{μ}) controller with 50 KW load increment, according to certain embodiments;

FIG. 12C illustrates frequency responses of a self-adjusting fractional-order proportional derivative (F-PD) controller with 50 KW load increment, according to certain embodiments;

FIG. 12D illustrates frequency responses of a fuzzy tuned fractional-order proportional derivative (F-FOPD^{μ}) controller with 50 KW load increment, according to certain embodiments;

FIG. 13A shows a graphical representation illustrating frequency responses of the FOPD^{μ} controller and the F-FOPD^{μ} controller with 50 kW load increment, according to certain embodiments;

FIG. 13B shows a graphical representation illustrating frequency responses of the FOPD^{μ} controller and the F-FOPD^{μ} controller with 50 kW load increment, according to certain embodiments;

FIG. 14 shows a graphical representation of asynchronous machine (ASM) speed (pu) of the F-FOPD^{μ} controller and the FOPD^{μ} controller, according to aspects of the present disclosure;

FIG. 15A illustrates graphical representations of voltages in pu for the PD controller, according to certain embodiments;

FIG. 15B illustrates graphical representations of voltages in pu for the FOPD^{μ} controller, according to certain embodiments;

FIG. 15C illustrate graphical representations of voltages in pu for the F-PD controller, according to certain embodiments;

FIG. 15D illustrate graphical representations of voltages in pu for the F-FOPD^{μ} controller, according to certain embodiments;

FIG. 16A show graphical representations of current in pu fed to the secondary load for the PD controller, according to certain embodiments;

FIG. 16B show graphical representations of current in pu fed to the secondary load for the FOPD^{μ} controller, according to certain embodiments;

FIG. 16C show graphical representations of current in pu fed to the secondary load for the F-PD controller, according to certain embodiments;

FIG. 16D show graphical representations of current in pu fed to the secondary load for the F-FOPD^{μ} controller, according to certain embodiments;

FIG. 17A shows graphical representations of active power (kW) from a wind energy module and reactive power (kvar) from ASM for the PD controller, according to certain embodiments;

FIG. 17B shows graphical representations of active power (kW) from a wind energy module and reactive power (kvar) from ASM for the FOPD^{μ} controller, according to certain embodiments;

FIG. 17C shows graphical representations of active power (kW) from a wind energy module and reactive power (kvar) from ASM for the F-PD controller, according to certain embodiments;

FIG. 17D shows graphical representations of active power (KW) from a wind energy module and reactive power (kvar) from ASM for the F-FOPD^{μ} controller, according to certain embodiments;

FIG. 18A shows graphical representations of frequency responses of the PD controller with 50 KW load decrement, according to certain embodiments;

FIG. 18B shows graphical representations of frequency responses of the FOPD^{μ} controller with 50 KW load decrement, according to certain embodiments;

FIG. 18C shows graphical representations of frequency responses of the F-PD controller with 50 KW load decrement, according to certain embodiments;

FIG. 18D shows graphical representations of frequency responses of the F-FOPD^{μ} controller with 50 KW load decrement, according to certain embodiments;

FIG. 19A shows graphical representations of ASM speed recovery after the fault of the PD controller, according to certain embodiments;

FIG. 19B shows graphical representations of ASM speed recovery after the fault of the FOPD^{μ} controller, according to certain embodiments;

FIG. 19C shows graphical representations of ASM speed recovery after the fault of the F-PD controller, according to certain embodiments;

FIG. 19D shows graphical representations of ASM speed recovery after the fault of the F-FOPD^{μ} controller, according to certain embodiments;

FIG. 20 shows a graphical representation illustrating the ASM speed of the FOPD^{μ} controller and the F-FOPD^{μ} controller, according to certain embodiments;

FIG. 21A shows graphical representations of currents in pu fed to the secondary load by the PD controller, according to certain embodiments;

FIG. 21B shows graphical representations of currents in pu fed to the secondary load by the FOPD^{μ} controller, according to certain embodiments;

FIG. 21C shows graphical representations of currents in pu fed to the secondary load by the F-PD controller, according to certain embodiments;

FIG. 21D shows graphical representations of currents in pu fed to the secondary load by the F-FOPD^{μ} controller, according to certain embodiments;

FIG. 22A shows graphical representations of frequency responses of the PD controller, for fault analysis, according to certain embodiments;

FIG. 22B shows graphical representations of frequency responses of the FOPD^{μ} controller, for fault analysis, according to certain embodiments;

FIG. 22C shows graphical representations of frequency responses of the F-PD controller, for fault analysis, according to certain embodiments;

FIG. 22D shows graphical representations of frequency responses of the F-FOPD^{μ} controller for fault analysis, according to certain embodiments;

FIG. 23A shows graphical representations of speed of recovery of ASM for the PD controller after clearing of fault in 5 cycles, according to certain embodiments;

FIG. 23B shows graphical representations of speed of recovery of ASM for the FOPD^{μ} controller after clearing of fault in 5 cycles, according to certain embodiments;

FIG. 23C shows graphical representations of speed of recovery of ASM for the F-PD controller after clearing of fault in 5 cycles, according to certain embodiments;

FIG. 23D shows graphical representations of speed of recovery of ASM for the F-FOPD^{μ} controller after clearing of fault in 5 cycles, according to certain embodiments;

FIG. 24 shows a bar chart of ITAE values for four different controllers with 50 kW load increment, according to certain embodiments;

FIG. 25 shows a bar chart of IAE values for four different controllers with 50 kW load increment, according to certain embodiments;

FIG. 26 shows a bar chart of ISE values for four different controllers with 50 kW load increment, according to certain embodiments;

FIG. 27 shows a bar chart of ITAE values for four different controllers with 50 kW load decrement, according to certain embodiments;

FIG. 28 shows a bar chart of IAE values for four different controllers with 50 kW load decrement, according to certain embodiments; and

FIG. 29 shows a bar chart of ISE values for four different controllers with 50 kW load decrement, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

The generation and flow of renewable energy can vary due to changing weather conditions leading to performance loss due to inefficient and redundant load matching activities for a renewable energy-based power system. These conditions also present a technical challenge to maintain the system's frequency within an acceptable range. The inconsistent nature of renewable energy sources can lead to power imbalances and frequency fluctuations at the load end. In cases where an asynchronous generator is used in wind energy system (WES), the speed variability of the wind turbine is restricted. Thus, the distributed control system for load frequency control has primarily been assessed only on isolated systems with dynamic load conditions.

In the embodiments herein, the implementation of a discrete-time control using a fuzzy tuned fractional-order proportional derivative (F-FOPD^{μ}) with a secondary load for load frequency control of renewable energy resources (such as WES, photovoltaic (PV), and full cell (FC) with battery energy storage system (BESS) is described. More particularly, the present disclosure is directed to a distributed control system coupled to a hybrid renewable power system for load frequency control. The distributed control system comprises a F-FOPD^{μ} controller for the hybrid power system. Under varying load conditions, the gains of the F-FOPD^{μ} controller are tuned automatically in an online approach by a fuzzy logic controller through application of a gain adjustment property, without execution of an algorithm as compared to conventional implementations of the FFOPD^{μ} controller. The system enhances the efficiency of the power system as well as decreases the transients.

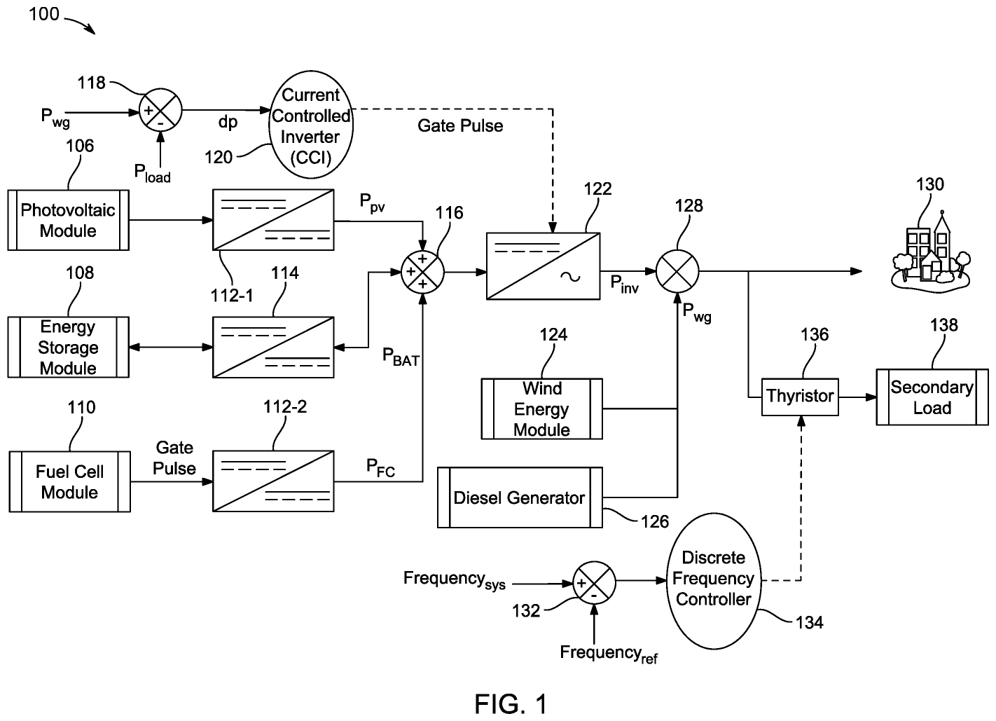

Turning to the figures, FIG. 1 illustrates a schematic diagram of a hybrid renewable power system 100, according to aspects of the present disclosure. The hybrid renewable power system 100, referred to as a hybrid system 100 hereinafter, is coupled to a distributed control system. The hybrid system 100 combines two or more renewable energy sources to generate electricity. In one implementation, the hybrid system 100 includes a direct current (DC) power section, an alternating current (AC) power section, and a primary load 130. The primary load 130 is connected to the AC power section of the hybrid system 100. The DC power section of the hybrid system 100 includes a plurality of DC renewable power modules configured to generate a DC power, and a plurality of DC-DC converters coupled to the plurality of DC renewable power modules. The plurality of DC-DC converters includes a first DC/DC boost converter 112-1, a second DC/DC boost converter 112-2, and a bidirectional DC/DC converter 114. The plurality of DC renewable power modules includes a photovoltaic module 106, a fuel cell module 110, and a battery energy storage module 108. Electric power produced from these sources is supplied to an isolated power load. The energy sources can be set up either as stand-alone systems or be connected directly to the grid. In a stand-alone setup, batteries are used for energy storage, while in a grid-connected arrangement, there is no need for batteries as the system is linked directly to the grid. The AC power section of the hybrid system 100 comprises a wind energy module 124 configured to generate a wind power. The wind energy module 124 includes a wind turbine and an induction generator, connected to the primary load 130. In an example, the induction generator has a capacity of 125 kW. This setup eliminates the necessity for power electronic devices, as the wind energy module 124 is directly linked to the primary load 130. The hybrid system 100 further includes a bidirectional insulated gate bipolar transistor (IGBT) 122. In an example, the IGBT 122 is a pulse width modulation (PWM) based IGBT 122. The IGBT 122 is a power electronic device that is configured to perform either inversion of power from DC to AC or rectification of power from AC to DC. In examples, PWM uses transistors that switch the DC voltage on and off in a defined sequence to produce the AC output voltage and frequency.

The distributed control system is configured to operate in time domain. In an implementation, the distributed control system is configured to return to steady state from up to 5 delay cycles in circuit breaker operations. The distributed control system includes a current-controlled inverter 120 and a discrete frequency controller 134. The current-controlled inverter 120 includes a proportional-integral controller. The proportional-integral controller 118 is coupled to the IGBT 122 of the hybrid system 100. The discrete frequency controller 134 is coupled to a secondary load 138. The discrete frequency controller 134 in power electronics refers to a control mechanism that is designed to regulate the frequency of a discrete-time power system efficiently and effectively. The discrete frequency controller 134 is implemented at the hybrid and renewable energy power systems as the generated power can be highly variable and dependent on various factors. The secondary load 138 includes a plurality of 8-bit 3-phase resistors and a plurality of switches. A plurality of gate turn-off thyristors 136 (individually referred to as gate turn-off thyristor 136) are connected between the discrete frequency controller 134 and the secondary load 138. The gate turn-off thyristor 136 is a type of thyristor that can be turned on and off by applying a signal to its gate terminal, unlike the standard thyristor, which can be turned on through the gate terminal but cannot be turned off unless the main current drops below a certain threshold. The threshold frequency is provided to the gate turn-off thyristor 136 by the discrete frequency controller 134. The discrete frequency controller 134 is configured to transfer an excess power generated in the AC power section to the secondary load 138.

The hybrid system 100 also includes a diesel generator 126 coupled to the wind energy module 124. In examples, the diesel generator 126 operates in wind only mode. The diesel generator 126 is a synchronous machine with a zero input and zero output. A voltage exciter is connected to the diesel generator 126 to balance out voltages of the distributed control system and the hybrid system 100. The diesel generator 126 is an electromechanical transducer that converts mechanical energy into electrical energy or vice versa. The diesel generator 126, with an inertia constant H of 1 second, is paired with the voltage exciter to ensure that the voltage across the hybrid system 100 remains balanced and stable.

The current-controlled inverter 120 configured to control a flow of power between the DC power section and the AC power section using a pair of power flow control signals. The proportional-integral controller of the current-controlled inverter 120 is configured to generate the pair of power flow control signals. The discrete frequency controller 134 is configured to perform a load frequency control of the hybrid system 100 using a pair of load frequency control signals. The load frequency control refers to controlling one or more frequency oscillations of the primary load 130.

In examples, the discrete frequency controller 134 is a discrete-time fuzzy tuned fractional-order proportional derivative controller. The fuzzy tuned fractional-order proportional derivative controller is configured to generate the pair of load frequency control signals based on a primary load frequency, a desired load frequency, and a rate of change of the primary load frequency. In examples, the proportional integral controller is configured to generate the pair of power flow control signals based on the primary load frequency and a pre-determined average frequency of the primary load. The fuzzy tuned fractional-order proportional derivative controller is configured to perform fuzzification using the primary load frequency, the desired load frequency, and the rate of change of the primary load frequency to generate a fuzzy value. The fuzzy tuned fractional-order proportional derivative controller is further configured to perform defuzzification through an inference mechanism to generate the pair of load frequency control signals from the fuzzy value.

The photovoltaic module 106 is coupled to the IGBT 122 through the first DC/DC boost converter 112-1. The first DC/DC boost converter 112-1 is a DC-to-DC converter with an output voltage greater than the source voltage. The first DC/DC boost converter 112-1 may alternatively be referred to as a step-up converter since it “steps up” the source voltage. The power generated by the photovoltaic module 106 is fed to a first comparator 116, denoted as “Pₚᵥ”, configured as an aggregator.

In an aspect, the battery energy storage module 108 is coupled to the PWM based IGBT 122 through the bidirectional DC/DC converter 114. The bidirectional DC/DC converter 114 is a power electronic device that can convert and transfer electrical energy efficiently between two DC sources or systems in both directions. For example, the bidirectional DC/DC converter 114 can regulate the power flow and voltage levels in two opposite directions, making it highly versatile and useful in applications like energy storage systems, hybrid electric vehicles, renewable energy systems, and other scenarios where energy needs to be stored and retrieved efficiently. The power generated by the battery energy storage module 108, denoted as “P_{BAT}”, is fed to the first comparator 116.

In an aspect, the fuel cell module 110 is coupled to the IGBT 122 through the second DC/DC boost converter 112-2. The power generated by the fuel cell module 110, denoted as “P_{FC}”, is fed to the first comparator 116. In an implementation, the first comparator 116 aggregates the Pₚᵥ, P_{BAT}, and P_{FC}. The aggregated output is fed to the IGBT 122 for conversion of DC to AC. In an aspect, the IGBT 122 is controlled by the current-controlled inverter 120. The current-controlled inverter 120 is configured to control a flow of power between the DC power section and the AC power section using a pair of power flow control signals.

The current-controlled inverter 120 is a type of power electronic device that converts DC into three-phase AC. The current-controlled inverter 120 controls the current waveform to ensure that the current waveform matches with desired parameters, making it especially useful in applications requiring precise current waveform control, such as motor drives and renewable energy systems. The current-controlled inverter 120 is fed with dP. The dP typically refers to the change in power, where “d” denotes a differential or a change, and “P” refers to power. As shown in FIG. 1, dP is calculated at a second comparator 118, based upon a differential of P_{wg} and P_{load}. P_{wg}, fed to the second comparator 118, represents the power that is generated by a wind turbine or a wind energy conversion system. P_{load}, fed to the second comparator 118, refers to the power that is consumed by a load or a group of loads. In electrical terms, a “load” is anything that consumes electrical power, such as appliances, machines, buildings, or even entire cities. The current-controlled inverter 120 is configured to control the IGBT 122 to utilize DC voltage generated by the photovoltaic module 106, the battery energy storage module 108, and the fuel cell module 110 to produce AC current in accordance with the dP fed to the current-controlled inverter 120. In an example, the current-controlled inverter 120 generates gate pulses to control the IGBT 122.

The IGBT 122 generates power output, denoted as “Pᵢₙᵥ”, based on the aggregated output received from the first comparator 116 and the gate pulses generated by the current-controlled inverter 120. The Pᵢₙᵥ is then fed to a third comparator 128. In an aspect, the third comparator 128, configured as an aggregator, receives two inputs, i.e., Pᵢₙᵥ and P_{wg}. The third comparator 128 receives Pᵢₙᵥ from the IGBT 122, and P_{wg} from the AC power section.

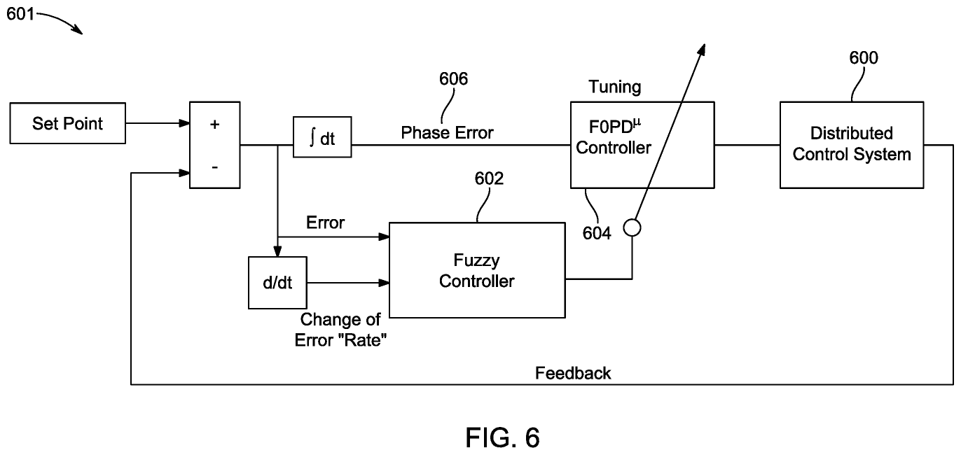

In contrast to the DC power section as described, the AC power section is equipped with the discrete frequency controller 134. The discrete frequency controller 134 indicates the presence of two distinct controllers, a characteristic of the distributed control system. The two distinct controllers forming the distributed control system are described further with reference to FIG. 6.

The current-controlled inverter 120 ensures a steady transition of power from the DC power section to the AC power section. Concurrently, the discrete frequency controller 134, positioned on the AC power section, functions as a secondary entity for load frequency control.

In examples, the power generated by the wind energy module 124 and the diesel generator 126, denoted as “P_{wg}”, is fed to the third comparator 128. The third comparator 128, in one aspect, is configured to aggregate the Pᵢₙᵥ and P_{wg} for generating the power output. The power output is then provided to the primary load 130.

The discrete frequency controller 134 is configured to perform a load frequency control of the hybrid system 100 using a pair of load frequency control signals. The load frequency control controls one or more frequency oscillations of the primary load 130. The discrete frequency controller 134 regulates the frequency based on a differential of Frequency_{sys} and Frequency_{ref}. In examples, Frequency sys refers to the actual operating frequency of the power system or electrical network at any given time. The system frequency depends on the balance between generated and consumed power and can vary with load changes, generation adjustments, and other dynamic factors. Frequency_{sys} is fed to a fourth comparator 132. Frequency_{ref} is the desired or target frequency at which a power system or a particular device or controller aims to operate. It acts as a setpoint against which the actual system frequency (Frequency_{sys}) is compared. Frequency_{ref} is also fed to the fourth comparator 132. In an aspect, the fourth comparator 132 is configured to generate the differential of Frequency_{sys} and Frequency_{ref}. Concisely, the differential of Frequency_{sys} and Frequency_{ref} is fed to the discrete frequency controller 134 for generation of regulated frequency, which is fed to the gate turn-off thyristor 136. Based on the frequency, the gate turn-off thyristor 136 turn ON or OFF its gates to let the power output received from the third comparator 128 flow to the secondary load 138.

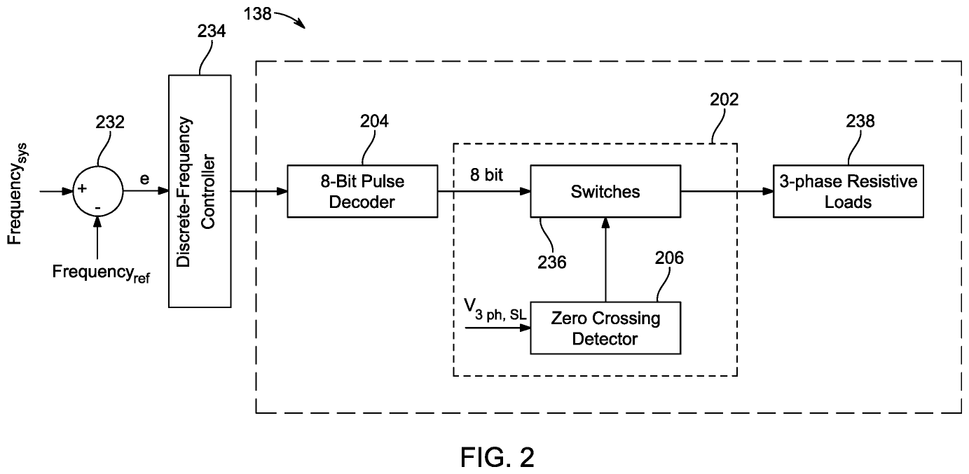

FIG. 2 illustrates a block diagram of the secondary load 138, according to aspects of the present disclosure.

In the example described in FIG. 2, Frequency_{sys} and Frequency_{ref} is fed to a comparator 232 (which is an example of the fourth comparator 132 of FIG. 1). The discrete frequency controller 234 (which is an example of the discrete frequency controller 134 of FIG. 1) regulates the frequency based on a differential of Frequency_{sys} and Frequency_{ref}. Output frequency from the discrete frequency controller 234 is fed to a sampling system 202. The sampling system 202 “measures” or “samples” a continuous signal at discrete intervals to convert it into a discrete signal for processing, analysis, or control purposes. The sampling system 202, in one aspect, includes, but may not be limited to, an 8-Bit pulse decoder 204, switches 236, a zero-crossing detector 206, and a 3-phase resistive load 238.

The 8-Bit pulse decoder 204 is a digital circuit designed to decode signals that have been encoded into 8-bit binary format. The 8-Bit pulse decoder 204 interprets the 8-bit binary code and converts it into an understandable or usable form, typically an analog signal or a control signal for further use. The 8-Bit pulse decoder 204 is configured to receive discrete frequency from the discrete frequency controller 234 to decode the signal into a format understandable by the switches 236. The switches 236 are coupled with a controlling mechanism configured to control the ON and OFF actions of the switches 236. In one example, the switches 236 are gate turn-off thyristors 136 as shown in FIG. 1. In one implementation, the controlling mechanism is the zero-crossing detector 206. The zero-crossing detector 206 is a circuit that detects the point where the voltage crosses zero in an AC waveform. The zero-crossing detector 206 is used in various applications to synchronize with the phase of the AC waveform, reduce switching losses, or eliminate electromagnetic interference during the switching operations. In an implementation, the switches 236 coupled with the zero-crossing detector 206 are configured to control the turning on and off of power connectivity of the 3-phase resistive loads 238 at the instant when the AC waveform crosses zero volts. This minimizes the switching loss and reduces electromagnetic interference and distortion in the waveform. When the switches 236 are ON, the power is fed to the resistive loads 238, referred earlier as secondary load 138. When the switches 236 are OFF, the power connectivity is turned OFF to the secondary load 138.

The power that the secondary load 138, as shown in FIG. 1, will absorb is provided by Equation (1).

$$( {I}_{0} + {I}_{1} {\text{.2}}^{1} + … + {I}_{7} {\text{.2}}^{7} ) . {P}_{STEP} \qquad ( 1 )$$

The power varies in the range 0 to 255×P_{STEP}. The P_{STEP} is the smallest step. It is the power of least significant bit. In examples, P_{STEP} is equal to 1.4 kW and total power absorbed by the secondary load 138 is P_{sec-nom} which is equal to 357 kW. The secondary load maximum power (P_{sec-nom}) is twice as greater as the P_{load-nom}, because of which the hybrid system 100 is regulated even with zero load. The control signal block uses the reference power P_{REF} sent by discrete frequency controller 134, converts into closest 8-bit binary digit (I₇-I₀) greater than or equal to the last stored result. The 8-bits regulates one 3-phase resistor by switching the related switches 236. The least significant bit (LSB) I₀ controls the smallest resistance of 1.4 kW.

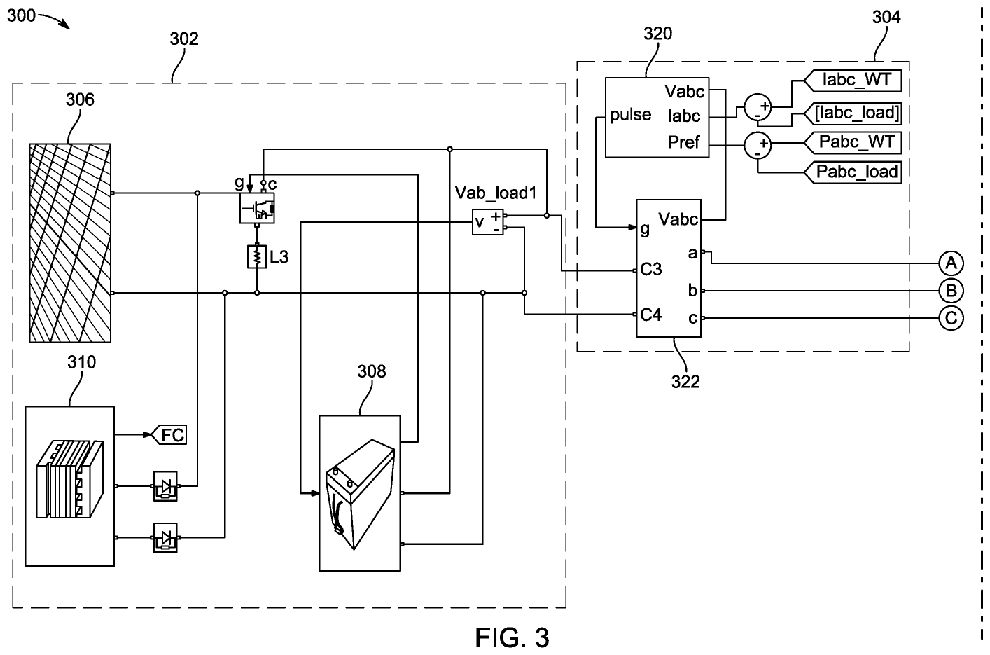

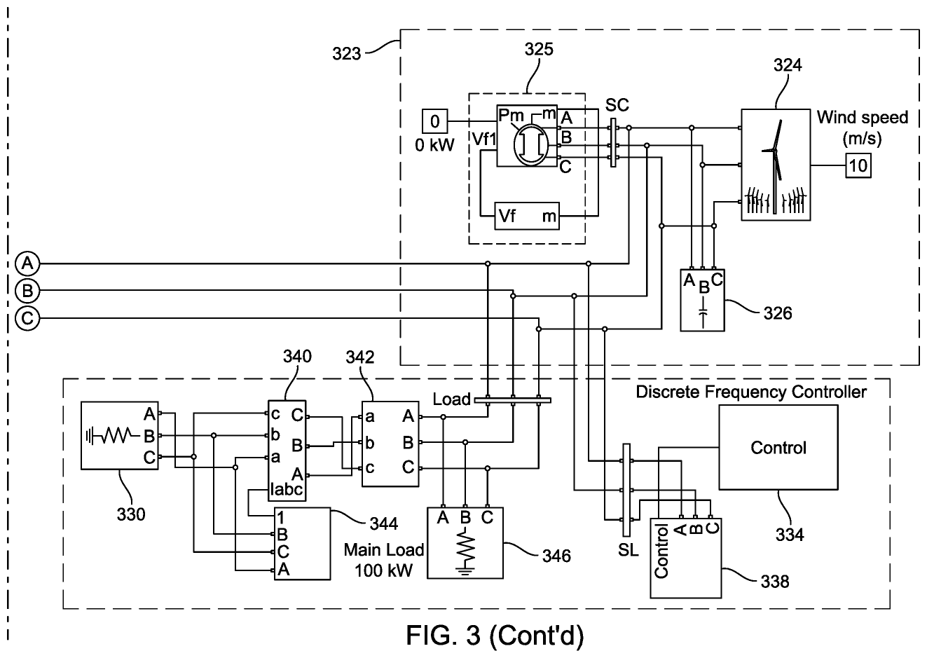

FIG. 3 illustrates a simulink diagram of a hybrid system 300 (which is an example of the hybrid system 100 of FIG. 1), according to aspects of the present disclosure. FIG. 3 should be viewed in conjunction with FIG. 1.

The hybrid system 300 includes a DC power section 302 and an AC power section 304. The hybrid system 300 includes a photovoltaic module 306 (which is an example of the photovoltaic module 106 of FIG. 1), a fuel cell module 310 (which is an example of the fuel cell module 110 of FIG. 1), and a battery energy storage module 308 (which is an example of the battery energy storage module 108 of FIG. 1) for energy storage. The hybrid system 300 can operate in isolation or be directly connected to the grid.

In examples, the photovoltaic module 306, the fuel cell module 310, and the battery energy storage module 308 are connected to a DC/AC converter 322. The hybrid system 300 also includes a current-controlled inverter 320 (which is an example of current-controlled inverter 120), that ensures the conversion of DC power to AC power according to the difference in generated and load power (dP). The current-controlled inverter 320 is fed with an input voltage (V_{abc}), an input current (I_{abc}), and reference power (Pref), based on which, a controlling pulse is generated to control the DC-AC converter 322.

The hybrid system 100 further includes a wind energy system 323. The wind energy system 323 includes a wind energy module 324 (which is an example of the wind energy module 124 of FIG. 1). The wind energy module 324 includes a wind turbine and an induction generator of 250 KW capacity, is directly connected to load 330 (50 KW) without the need for power electronic devices. The wind energy module 324, even while operating at zero input, assists in voltage regulation of the hybrid system 300 as a voltage regulator 325. In an aspect, the wind energy module 324 and the voltage regulator 325 are connected to a power Factor (PF) correction capacitor 326. In an example, the PF correction capacitor 326 is of 75 kvar. The PF correction capacitor 326 is implemented to improve the power factor of the hybrid system 300.

The current-controlled inverter 320 and a discrete frequency controller 334 on the AC power section 304 are configured to manage the flow of electricity, rendering the hybrid system 300 as a distributed control system. The power output from the DC power section 302 and the AC power section 304 is combined to supply electricity to the load 330, ensuring an efficient and balanced energy supply.

The power generated is fed to the load 330 and a secondary load 338 (which is an example of the secondary load 138 of FIG. 1). The load 330 and the secondary load 338 receive the power connection through a stability mechanism that includes of 3-phase breaker 342, a 3-phase fault 344, and a measure circuit 340. In an aspect, a consumer load 346 is configured to receive the power directly from the DC-AC converter 322. The secondary load 338, in an aspect, is coupled to the discrete frequency controller 334 configured to turn the gates ON and OFF for connecting the secondary load 338 to the power signal or disconnecting the secondary load 338 from the power signal, respectively.

In an aspect, the hybrid system 300 takes active power reference as the difference of P_{abc-WT} and P_{abc_load} in per unit value, because if the wind energy module 324 is not sufficient to power the load it takes the remaining power from the DC power section 302 of the hybrid system 300.

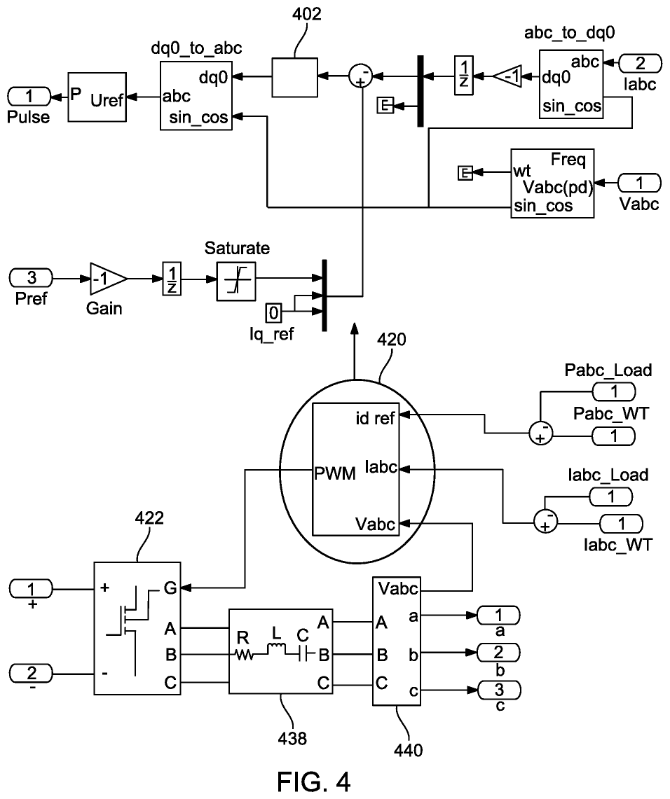

FIG. 4 illustrates a simulink model of a current-controlled inverter 420 (which is an example of the current-controlled inverter 320 of FIG. 3), according to aspects of the present disclosure.

Referring to FIG. 1 and FIG. 3, in examples, power reference is transmitted in inverter mode operation. If the difference of P_{abc-WT} and P_{abc_load}, is greater than zero, then the current-controlled inverter 420 transmits power to the AC segment 304 of the hybrid system 300 towards the load and consume power from the photovoltaic module (106, 306), the fuel cell module (110, 310), and the battery energy storage module (108, 308). In the rectifier mode operation, difference of P_{abc-WT} and P_{abc_load} is less than equal to zero, then current-controlled inverter 420 takes power from the wind energy module (324, 124) and load side to charge the battery energy storage module (108, 308). For the sake of simplicity of the system inverter's reactive power is set to 0, even though it can consume/produce the reactive power.

The IGBT 422 (which is an example of the IGBT 122 of FIG. 1) generally operates at a switching frequency in the range of about 1 kHz to 20 kHz. In the present disclosure the IGBT 422 operates at a switching frequency of 2.5 kHz and is equipped with a filter 438, the filter 438 can be an LC filter consisting of a capacitor and an inductor. In the present disclosure, the capacitor has a value of 6.85 μF and the inductor has a value of 2 mH. The IGBT 422 works within a rotating dq coordinate reference and employs a standard phase-locked loop (PLL) that uses the waveform of the load voltage as the reference for coordinating conversions. Active and reactive currents are managed using a proportional-integral controller 402. In an aspect, the proportional-integral controller 402 is configured to generate a pair of power flow control signals based on the primary load frequency and a pre-determined average frequency of the primary load.

When all values are considered in per unit, and the voltage is near 1, the id-reference equates to the power reference, and iq-reference is set to zero, ensuring that the current-controlled inverter 420 operates at unity power factor. In an example, with a Kp value of 1 and a Ki value of 200, and a sample time of 0.5 ms, the current-controlled inverter 420 response is sufficiently robust for managing the load frequency control of the hybrid system. Given the discrete nature of the hybrid system, in an example embodiment, the secondary load (138, 338) is consumed in discrete steps of 1.4 kW.

In an aspect, the discrete frequency controller is coupled to a secondary load. The discrete frequency controller is further configured to transfer an excess power generated in the AC power section to the secondary load. A plurality of gate turn-off thyristors are connected between the discrete frequency controller and the secondary load. The discrete frequency controller can be a fractional-integration and fractional differentiation of fuzzy tuned fractional-order proportional derivative μ (F-FOPDμ) controller.

It is to be noted that, in the present disclosure, the gains of the F-FOPD^{μ} controller are tuned automatically in an online approach by a fuzzy logic controller through application of a gain adjustment property, without execution of an algorithm as compared to conventional implementations of the FFOPD^{μ} controller

The concepts of the fractional-integration and fractional differentiation of F-FOPD^{μ} controllers are described with the Cauchy formula. The Cauchy formula provides the repeated integration.

$${I}^{n} f ( x ) = \frac{1}{( n - 1 ) !} {\int }_{a}^{x} {( x - t )}^{n - 1} f ( t ) dt \qquad ( 2 )$$

The main factor limiting the domain of the formula for repeated integration is the factorial operative (n−1)! which can be replaced with Gamma function Γ(n). The Gamma function Γ(n) stands for:

$$\begin{matrix}Γ ( n ) = {\int }_{0}^{∞} {e}^{- t} {t}^{n - 1} dt & for n ε N\end{matrix} \qquad ( 3 )$$

$${I}^{n} \begin{matrix}f ( x ) = \frac{1}{Γ ( n )} {\int }_{a}^{x} {( x - t )}^{n - 1} dt & for n ε C ,\end{matrix} \qquad ( 4 )$$

The fractional derivative is computed by Riemann-Liouville formula for fractional derivative, which is expressed as follows:

$$\frac{{d}^{n} f}{{dx}^{n}} ( {I}^{n} f ( t ) ) = f ( t ) \qquad ( 5 )$$

The fractional derivative is hence given by:

$${D}^{n} f = \frac{{d}^{[ n ]}}{{dx}^{[ n ]}} ( {I}^{[ n ] - n} f ) \qquad ( 6 )$$

Where ┌n┐ is the ceil of n, if its value is in fraction that can be round-off. Now using the Cauchy formula for repeated integration:

$${I}^{n} f ( x ) = \frac{1}{( n - 1 ) !} {\int }_{a}^{x} {( x - t )}^{n - 1} f ( t ) dt \qquad ( 7 )$$

Accordingly, the formula for fractional derivative in terms of regular positive integer differentiation and fractional integration is expressed as follows:

$${D}_{a}^{n} f ( x ) = \frac{1}{Γ ( [ n ] - n )} \frac{{d}^{[ n ]}}{dx [ n ]} {\int }_{a}^{x} {( x - t )}^{[ n ] - n - 1} f ( t ) dt \qquad ( 8 )$$

Equation (8) provided above shows that, Dⁿ not only depends on inputs but also on the limit “a”. This is left Riemann-Liouville fractional derivative. The first and second derivative is taken, and the output only depends on the value of input (this is called locality). However, in fractional derivative, the output also depends on the value of “a”. Thus, the fractional derivative has the non-locality. This is useful in analyzing those function that does not only depend on time. For example, some phenomena are impacted by the memory effect where the current state not only depends on time but also on previous states. Combining fractional differentiation and fractional integration, a differ-integral operator may be given by:

$${J}^{a} f = \{ \begin{matrix}{D}^{a} f & if a > 0 \\ f & if a = 0 \\ {I}^{\vert a \vert} & if a < 0\end{matrix} \qquad ( 9 )$$

The FOPD^{μ} controller thus has 3 degrees of freedom than the conventional PD controller. This gives FOPD^{μ} controller the better control mechanism to enhance the performance character. It helps the hybrid system (100, 300) to have quicker response time and has less overshoot and settling time. The control equation of FOPD^{μ} controller is as follow:

$$u ( t ) = {k}_{p} e ( t ) + {k}_{d} {D}^{μ} e ( t ) \qquad ( 10 )$$

Here, e(t) is the error signal. The equation Laplace form is given as follows:

$${G}_{c} ( s ) = {k}_{p} + {k}_{d} {s}^{μ} \qquad ( 11 )$$

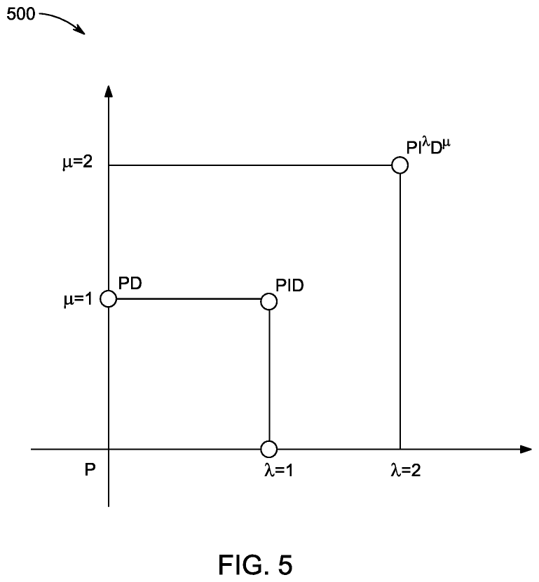

FIG. 5 illustrates a fractional PI^{λ}D^{μ} controller graph 500 (hereinafter referred to as graph 500), according to aspects of the present disclosure. The graph 500 indicates that if λ=1 and μ=1, the consequent is simple PID controller 501, if λ=1, μ=0 it is a classical PI controller 502, and finally if μ=1 and λ=0, the controller becomes the classical PD controller 503. When λ=2, μ=2, the consequent is PI^{λ}D^{μ} controller.

FIG. 6 illustrates a schematic diagram of a F-FOPDμ controller 601, according to aspects of the present disclosure. The F-FOPDμ controller 601 mainly includes a fuzzy controller 602 and a FOPDμ controller 604 forming a distributed control system 600. The FOPDμ controller 604 is configured to generate a pair of load frequency control signals based on a primary load frequency, a desired load frequency, and a rate of change of the primary load frequency. The distributed control system 600 is configured to return to steady state from up to 5 delay cycles in circuit breaker operations, and operate in time domain.

As known in the art, the distributed control system has been commonly used in various applications focused on stand-alone hybrid systems, particularly for directing excess power to a secondary load. In the hybrid system, which is composed of multiple renewable energy sources, the balance points shift continuously due to fluctuating load conditions. To address this, flexible distributed control schemes are preferred over fixed controllers, thereby effectively reducing operational costs, and adapting to varying conditions.

The fuzzy controller 602 is a type of control system that deals with imprecise and uncertain information, making decisions based on a set of “fuzzy” rules rather than precise mathematical models. Fuzzy logic mimics human reasoning and decision-making processes. The fuzzy controller 602 considers all the possibilities between absolute true and false, and thus provides a means to deal with uncertainty and vagueness. The FOPDμ controller 604 is based on the concept of conventional integer-order PID controllers by introduction of fractional calculus. Such controllers offer an additional degree of freedom through the fractional orders, leading to enhanced performance in various applications.

Referring back to FIG. 6, the fuzzy controller 602 receives two inputs, an error, and a change of error “rate”. The fuzzy rules generate two tuned outputs [symbol] and [symbol] . The outputs from the fuzzy logic are then added with the fixed coefficient of kₚ⁰ and k_{d}⁰ and fed to the FOPD^{μ} controller 604.

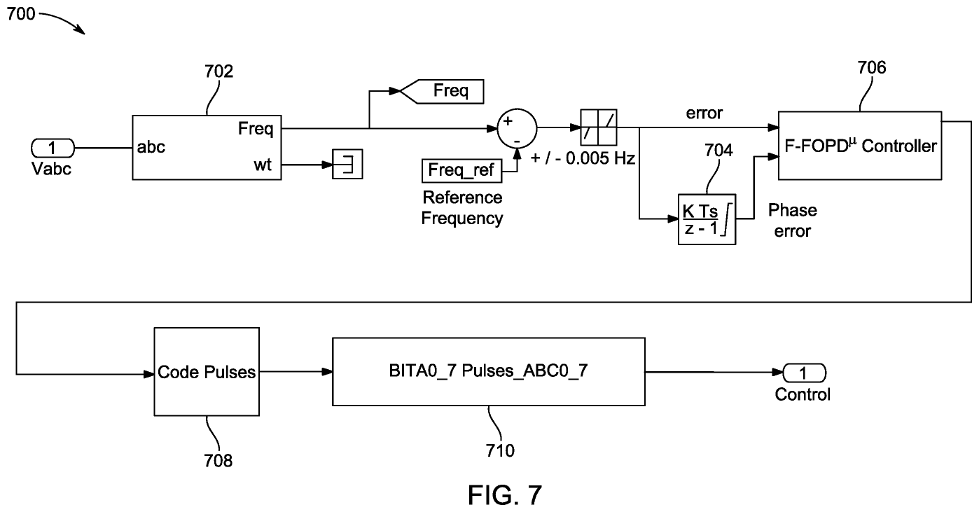

FIG. 7 shows a Simulink mode of a discrete frequency regulator 700, according to aspects of the present disclosure. FIG. 7 should be viewed in conjunction with FIG. 6. As shown in FIG. 7, a phase-locked loop (PLL) 702 is connected to the F-FOPDμ controller 706 and a discrete-time integrator 704. The PLL 702 is a control system that generates an output signal whose phase is related to the phase of an input signal. Output of the F-FOPDμ controller 706 is fed to the pulse decoder 708 to decode the output of the F-FOPDμ controller 706 into usable format. The output of the pulse decoder 708 is fed to the sampling system 710.

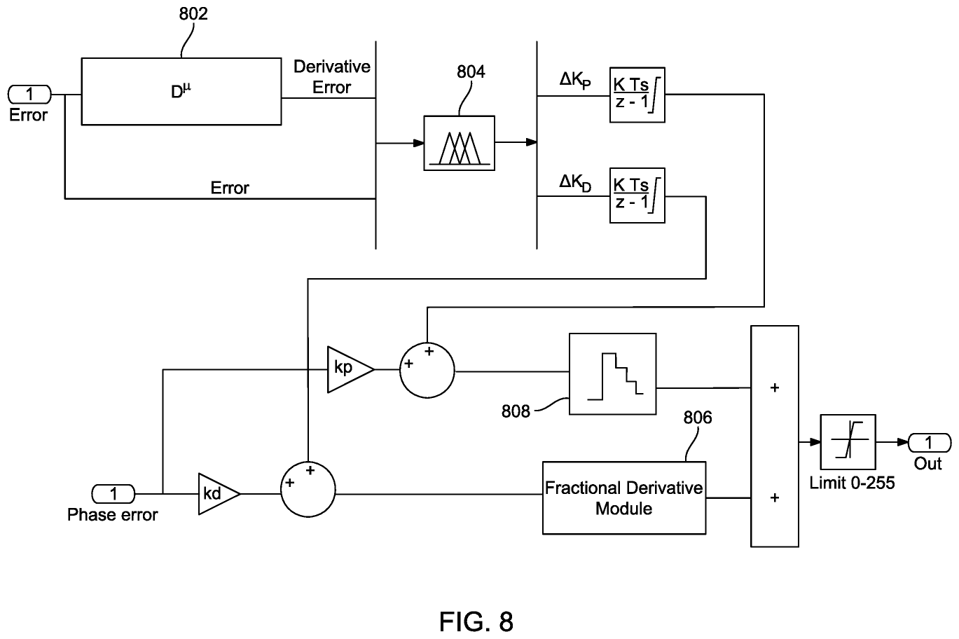

FIG. 8 shows a Simulink model of F-FOPD^{μ} controller 804 (which is an example of the F-FOPD^{μ} controller 706 of FIG. 7), according to aspects of the present disclosure. As shown in FIG. 8, derivative of error signal 802 is fed to the F-FOPD^{μ} controller 804. The proportional gain (K_{P}) and derivative gain (K_{D}) parameters are modified by the fractional derivative module 806 and a zero-order hold module 808. This is referred to as the online approach of self-tuning the gains of the FFOPD^{μ} controller 804, without implementation of an algorithm. The zero-order hold (ZOH) is a signal processing technique used in digital control and digital signal processing systems for converting a discrete-time signal into a continuous-time signal. FIG. 8 illustrates addition of the tuned ( [symbol] , [symbol] ) and fixed (kₚ⁰, k_{d}⁰) coefficients.

$${k}_{p} = {k}_{p}^{0} + {k}_{p}^{\sim} \qquad ( 12 )$$

$${k}_{d} = {k}_{d}^{0} + {k}_{d}^{\sim} \qquad ( 13 )$$

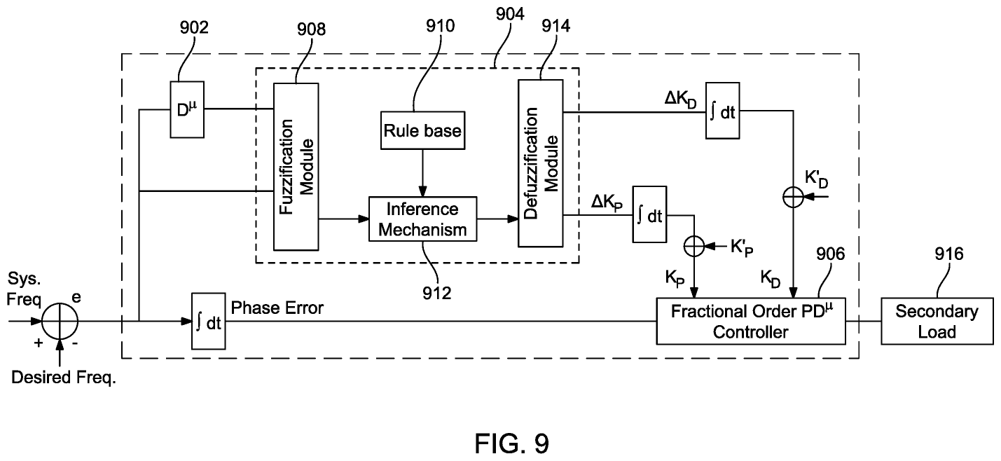

FIG. 9 shows a schematic of a F-FOPD^{μ} controller 904 (which is an example of the F-FOPD^{μ} controller 804 of FIG. 8) with a fuzzification module 908, an inference mechanism 912 and a defuzzification module 914, according to aspects of the present disclosure. The F-FOPD^{μ} controller 904 is a decision-making system that operates based on a set of “if-then” rules, known as fuzzy rules. The fuzzy rules established based on the observation of a designer of the F-FOPD^{μ} controller 904 and expertise of the operator of the system, guide the controller's responses. The system functions by measuring the error signal, which is the difference between the actual frequency and the reference frequency. This error signal, along with its rate of change, serves as the input for the F-FOPD^{μ} controller 904. By assessing how far and how fast the frequency is deviating from the desired point, the F-FOPD^{μ} controller 904 adapts its output to optimize the response of the hybrid system. The output from the F-FOPD^{μ} controller 904 modifies both proportional gain (K_{P}) and derivative gain (K_{D}) parameters, ensuring that the system adjusts effectively to various conditions. The proportional gain parameter adjusts the output of the F-FOPD^{μ} controller 904 in proportion to the error signal. The error signal is the difference between the setpoint (desired value) and the process variable (current value). The derivative gain parameter indicates the rate of change of the error signal. The derivative gain parameter provides a control action to counteract the rate of error change, helping to minimize overshoot and oscillations.

As shown in FIG. 9, an error signal is calculated by generating a differential of a system frequency and a desired frequency. A derivative of the error signal is fed to the F-FOPD^{μ} controller 904. The F-FOPD^{μ} controller 904 includes the fuzzification module 908, the inference mechanism 912, a rule base 910, and the defuzzification module 914. The fuzzification module 908 is configured to receive fractional derivative input 902. Here, an entry point where crisp numerical data is converted into fuzzy sets or linguistic variables. The transformation process allows the F-FOPD^{μ} controller 904 to handle imprecise, uncertain, and subjective data effectively. The converted input signal is applied with the rule base 910 containing fuzzy rules. The rule base 910 is controlled by the inference mechanism 912 that determines how decisions are made based on the given fuzzy logic rules and the current input values. The inference mechanism 912 interprets and processes fuzzy rules to derive a control action. The defuzzification module 914 is configured to modify the K_{P} and the K_{P} parameters. Modified K_{P} and K_{D} are fed to the Fractional Order-FOPD^{μ} controller 906. Power output, with enhanced parameters, are then fed to the secondary load 916.

Implementing the secondary load approach has the added advantage of compatibility with more cost-effective and simpler wind turbine designs. Integration of the secondary load enables the hybrid system 100, 300 for powering remote areas where both cost and ease of maintenance are critical considerations. The need for intricate plant modelling is also eliminated since the energy consumption of the secondary load adjusts based on the frequency variations of the system.

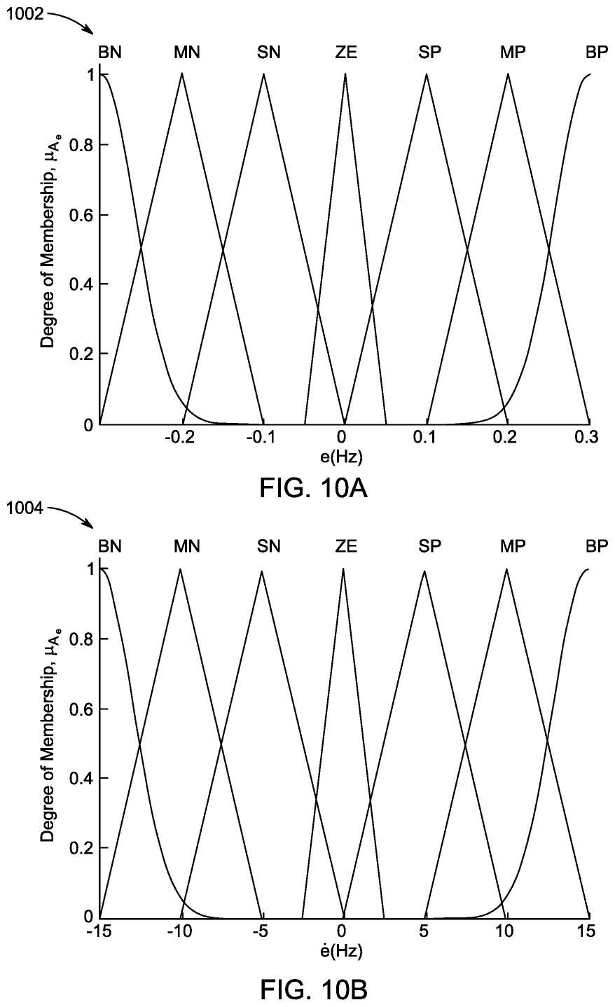

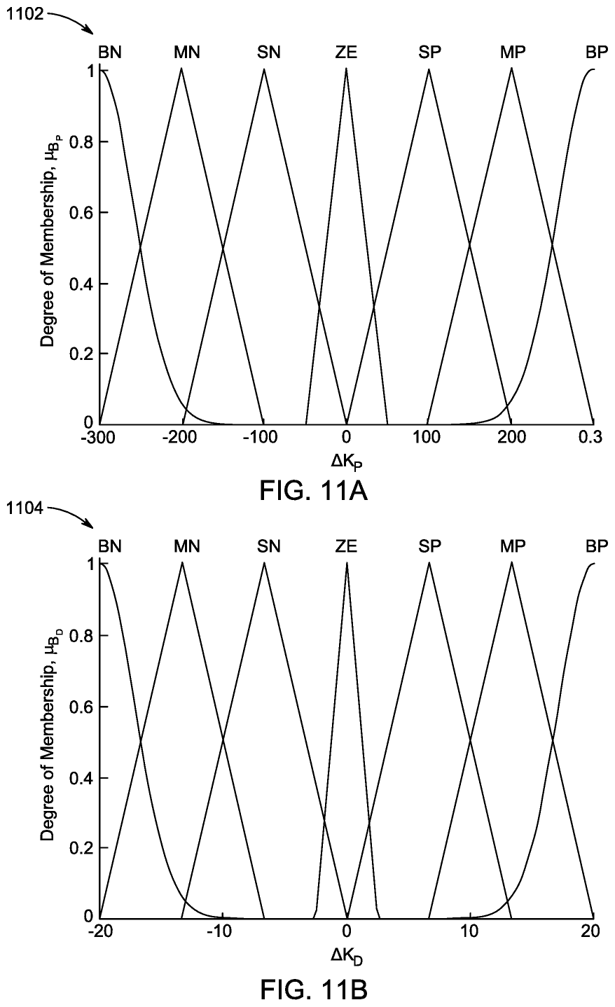

FIG. 10A illustrates a graphical representation 1002 of membership functions for an input “error”, according to aspects of the present disclosure. FIG. 10B illustrates a graphical representation 1004 of membership functions for an input “change in error”, according to aspects of the present disclosure. FIG. 11A illustrates a graphical representation 1102 of membership functions for an output “ΔK_{P}”, according to aspects of the present disclosure. FIG. 11B illustrates a graphical representation 1104 of membership functions for an output “ΔK_{D}”, according to aspects of the present disclosure.

In an implementation, the decision based on fuzzy logic rules is made by the inference mechanism 912 that gives the output value. The inference mechanism 912 makes assessments of fuzzy value to output. The decision depends on fuzzification of the inputs matrix's membership values as shown in are shown in FIGS. 10A, 10B, 11A, and 11B.

The rules of fuzzy control developed on trial-and-error method are listed in Table 1 and Table 2.

TABLE 1
ΔK_{P} Fuzzy Rules
ė

| | | | | | | | |
|---|---|---|---|---|---|---|---|
| E | BN | MN | SN | ZE | SP | MP | BP |
| BN | BN | BN | MN | MN | SN | ZE | ZE |
| MN | BN | BN | MN | SN | SN | ZE | SP |
| SN | MN | MN | MN | SN | ZE | SP | SP |
| ZE | MN | MN | SP | ZE | SP | MP | MP |
| SP | SN | SN | ZE | SP | SP | MP | MP |
| MP | SN | ZE | SP | MP | MP | MP | BP |
| BP | ZE | ZE | MP | MP | MP | BP | BP |

TABLE 2
ΔK_{D} Fuzzy Rules
ė

| | | | | | | | |
|---|---|---|---|---|---|---|---|
| e | BN | MN | SN | ZE | SP | MP | BP |
| BN | SP | SN | BN | BN | BN | MN | SP |
| MN | SP | SN | BN | MN | MN | SN | ZE |
| SN | ZE | SN | MN | MN | SN | SN | ZE |
| ZE | ZE | SN | SN | SN | SN | SN | ZE |
| SP | ZE | ZE | ZE | ZE | ZE | ZE | ZE |
| MP | BP | SN | SP | SP | SP | SP | BP |
| BP | BP | MP | MP | MP | SP | SP | BP |

The Table 1 and Table 2 give 49 fuzzy rules by the trial and error-based for self-setting modules. Seven syntactical variables that are small negative (SN), big negative (BN), negative medium negative (MN), zero (ZE), small positive (SP), medium positive (MP), and big positive (BP). Each of these linguistic is given a fuzzy membership value. These variables are used for fuzzification. The error and rate of change of error go under the fuzzification from real scalar value to fuzzy values.

The planning of ΔK_{P} input and output values is given in Table 1 based on the following rule:
Rule j: e is Aₑⁱ and e⋅ is Aₑ^{.i} then ΔK_{P} is Bₚⁱ; i=1, 49

The planning of ΔK_{D} input and output values is given in Table 2 considering the following rule:
Rule k: e is Aₑ^{j} and e⋅ is Aₑ^{.j} then ΔK_{D} is B_{D}ⁱ; j=1, 49

B_{P} and B_{D} are the changes of proportional and derivative gain output variables, Aₑ and A_{ė} depicts the error and the rate of change in error of the input variables, respectively.

To get precise values of ΔK_{P} and ΔK_{D}, the present embodiment implements the centroid of area (COA) method or center of gravity (COG) method, instead of fuzzified values, which determine the mid-value of the center of area under the curve. The total area is divided into smaller membership functions. The combined area of all the parts accumulatively gives the overall control action. The centroid or center of each part is determined. The sum of these centroid values of each sub-area is used to find the defuzzified crisp value again of the discrete set. The Equation (14) provided below uses the COG method to calculate the X* defuzzified value for discrete membership functions.

$${X}^{*} = \frac{{\sum }_{i = 1}^{n} {x}_{i} \cdot μ ( {x}_{i} )}{{\sum }_{i = 1}^{n} μ ( {x}_{i} )} \qquad ( 14 )$$

where, xᵢ donates the centroid of i^{th} area or the sampling element, μ(xᵢ) gives the area under the curve or the membership function of i^{th} area, and n is the number of elements in the sample. To compute the crisp value of continuous membership functions X*, the formula is expressed as:

$${X}^{*} = \frac{\int x \cdot {μ}_{A} ( x ) dx}{\int x {μ}_{A} ( x ) dx} \qquad ( 15 )$$

Here, x donates the centroid element, μ_{A}(x) is the membership function, and n shows the number of elements in the sample.

$$Δ {K}_{P} = \frac{{\int }_{Δ {K}_{P}} \begin{matrix}49 \\ ⋁ \\ i = 1\end{matrix} [ ( {μ}_{{A}_{e}^{i}} ( e ) \hat{} {μ}_{{A}_{\dot{e}}^{i}} ( \dot{e} ) ) \hat{} {μ}_{{B}_{P}^{i}} ( Δ {K}_{P} ) ] Δ {K}_{P} d ( Δ {K}_{P} )}{{\int }_{Δ {K}_{P}} \begin{matrix}49 \\ ⋁ \\ i = 1\end{matrix} [ ( {μ}_{{A}_{e}^{i}} ( e ) \hat{} {μ}_{{A}_{\dot{e}}^{i}} ( \dot{e} ) ) \hat{} {μ}_{{B}_{P}^{i}} ( Δ {K}_{P} ) ] d ( Δ {K}_{P} )} \qquad ( 16 )$$

$$Δ {K}_{D} = \frac{{\int }_{Δ {K}_{D}} \begin{matrix}49 \\ ⋁ \\ j = 1\end{matrix} [ ( {μ}_{{A}_{e}^{j}} ( e ) \hat{} {μ}_{{A}_{\dot{e}}^{j}} ( \dot{e} ) ) \hat{} {μ}_{{B}_{D}^{j}} ( Δ {K}_{D} ) ] Δ {K}_{D} d ( Δ {K}_{D} )}{{\int }_{Δ {K}_{D}} \begin{matrix}49 \\ ⋁ \\ j = 1\end{matrix} [ ( {μ}_{{A}_{e}^{j}} ( e ) \hat{} {μ}_{{A}_{\dot{e}}^{j}} ( \dot{e} ) ) \hat{} {μ}_{{B}_{D}^{j}} ( Δ {K}_{D} ) ] d ( Δ {K}_{D} )} \qquad ( 17 )$$

Here, V is a symbol that refers to maximum and A is the symbol referring to minimum operative. Also, magnitude of K′_{P} and K′_{D} changes along magnitudes of ΔK_{P} and ΔK_{P} for balanced system performance.

### Examples

The following examples describe and demonstrate exemplary embodiments as described herein. The examples are provided solely for the purpose of illustration and are not to be construed as limitations of the present disclosure, as many variations thereof are possible without departing from the spirit and scope of the present disclosure.

### Experimental Data and Analysis

In the experiment, the simulations start from a stable state and proceed uninterrupted for one second, with the voltage, power, frequency, the speed of the asynchronous machine (ASM), and current pre-set to stable values. The load frequency control performance of the F-FOPD^{μ} is evaluated against classical PD, self-tuned F-PD, and FOPD^{μ} under conditions of a 50-kW increase or decrease in load and during faults. A synchronous machine, operating as a synchronous condenser, ensures the system's voltage and power factor remain constant.

After the initial second, the ASM starts operating at a speed slightly exceeding 1.011 per unit (pu), indicative of a speed marginally above the synchronous speed, characteristic of its generation mode. Consequently, the currents adapt to new stable levels, compensating for the increased power demand without inducing voltage fluctuations.

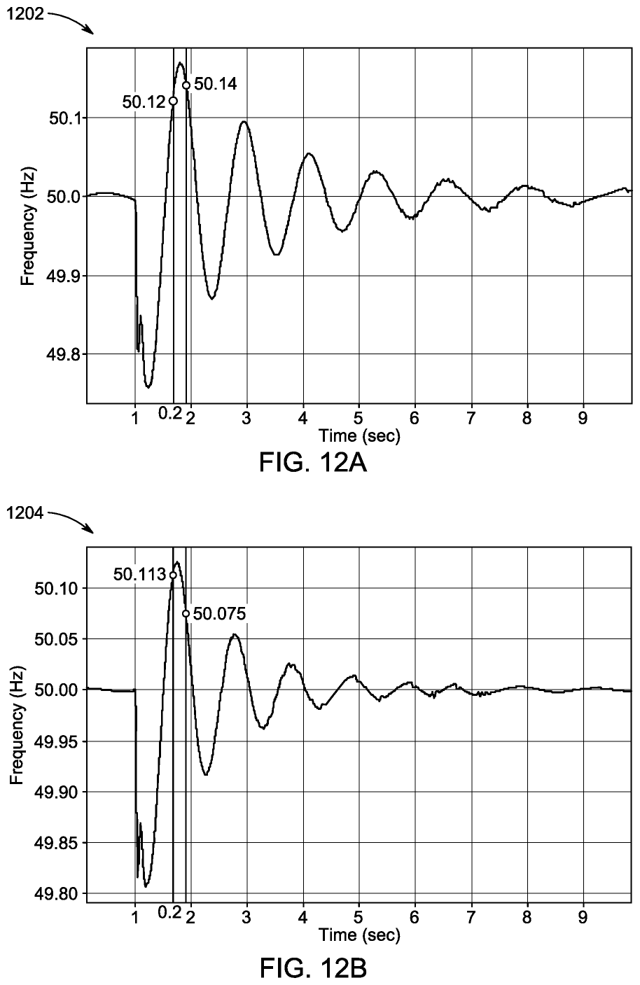

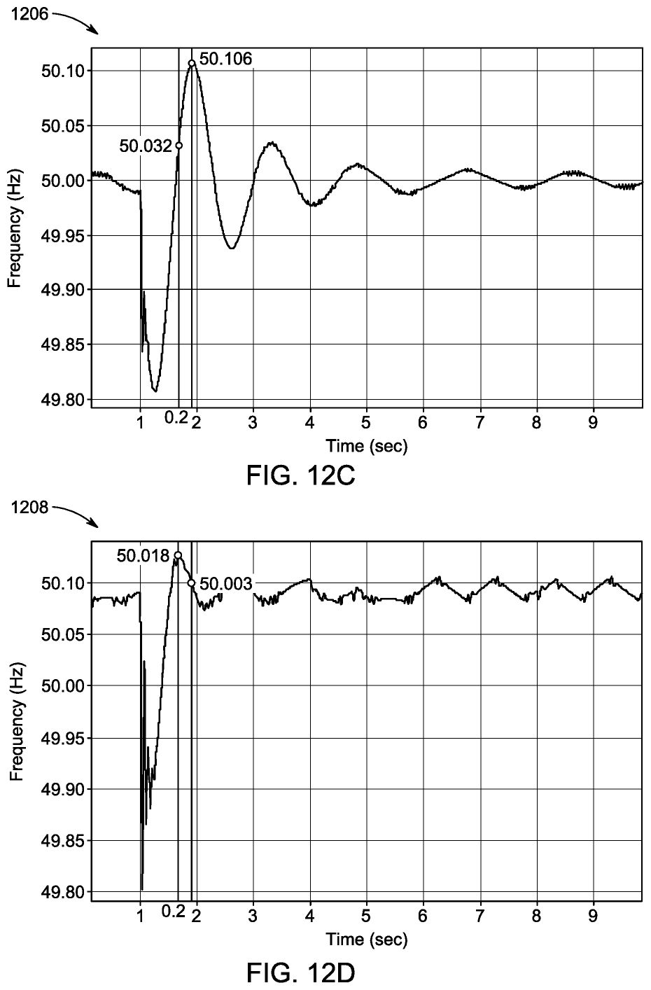

FIGS. 12A, 12B, 12C, and 12D illustrate frequency responses of a classical proportional derivative (PD) controller, a fractional-order proportional derivative (FOPD^{μ}) controller, a self-adjusting fractional proportional derivative (F-PD) controller, and a fuzzy tuned fractional-order proportional derivative (F-FOPD^{μ}) controller with 50 KW load increment. At interval t=1 sec, 50 kW of load was added to the hybrid system (100, 300). The frequency responses are plotted with respect to time.

FIG. 12A shows a graphical representation 1202 illustrating a frequency response of a classical proportional derivative (PD) controller with 50 KW load increment, according to aspects of the present disclosure. FIG. 12A shows a frequency response of the classical PD controller at interval t=1 sec and 50 kW of load.

FIG. 12B shows a graphical representation 1204 illustrating a frequency response of a fractional-order proportional derivative (FOPD^{μ}) controller with 50 KW load increment, according to aspects of the present disclosure. FIG. 12B shows a frequency response of the FOPD^{μ} controller at interval t=1 sec and 50 kW of load.

FIG. 12C shows a graphical representation 1206 illustrating a frequency response of a self-adjusting fractional proportional derivative (F-PD) controller with 50 KW load increment, according to aspects of the present disclosure. FIG. 12C shows a frequency response of the F-PD controller at interval t=1 sec and 50 kW of load.

FIG. 12D shows a graphical representation 1208 illustrating a frequency response of a fuzzy tuned fractional-order proportional derivative (F-FOPD^{μ}) controller with 50 KW load increment, according to aspects of the present disclosure. FIG. 12D shows a frequency response of the F-FOPD^{μ} controller at interval t=1 sec and 50 kW of load.

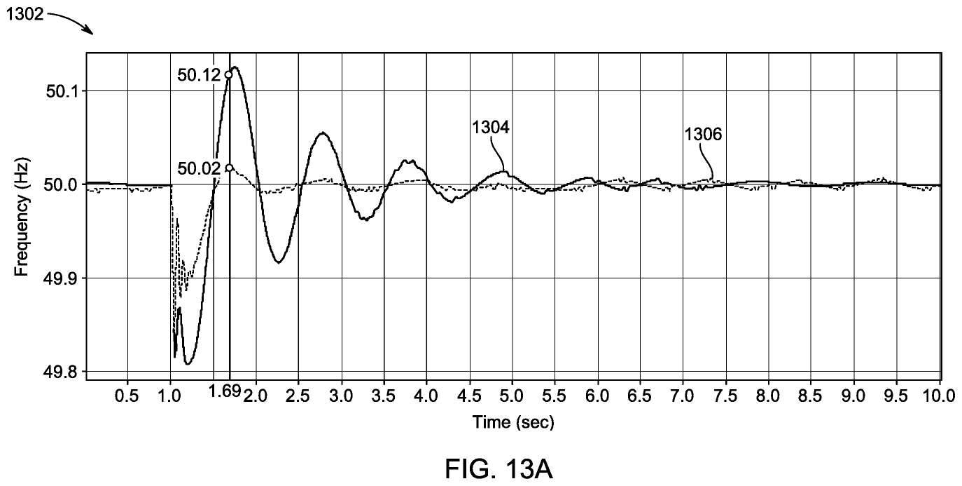

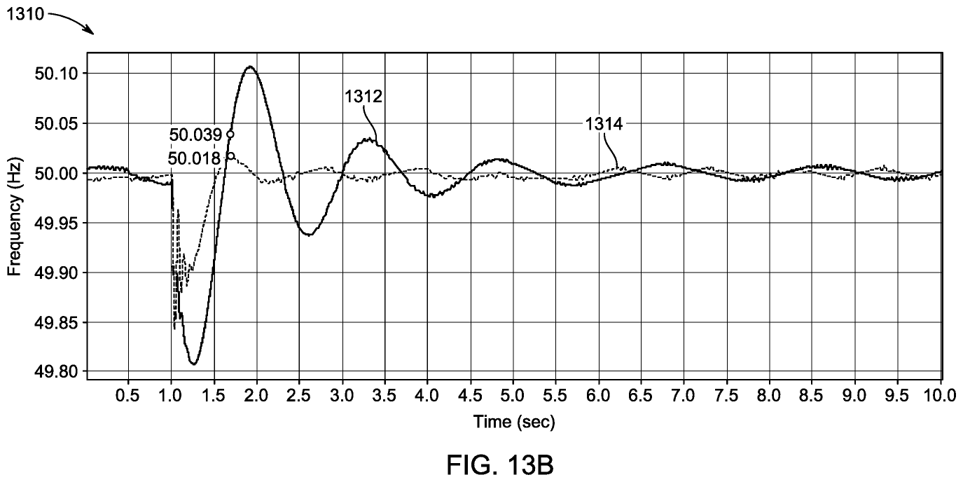

FIG. 13A shows a graphical representation 1302 illustrating frequency responses of a FOPD^{μ} controller and a F-FOPD^{μ} controller with 50 kW load increment, according to aspects of the present disclosure. The frequency response of the FOPD^{μ} controller is shown by a plot line 1304 and the frequency responses of the F-FOPD^{μ} controller is shown by a plot line 1306.

FIG. 13B shows a graphical representation 1310 illustrating frequency responses of a FOPD^{μ} controller and a F-FOPD^{μ} controller with 50 kW load increment, according to aspects of the present disclosure. The frequency response of the FOPD^{μ} controller is shown by a plot line 1312 and the frequency responses of the F-FOPD^{μ} controller is shown by a plot line 1314.

As can be seen in FIG. 13A and FIG. 13B, in comparison to other controllers, the F-FOPD^{μ} controller recovers the drop in frequency from 49.80 Hz to 50 Hz within few milliseconds, by cutting down the excess power taken by secondary load. The maximum overshoot, observed in frequency of F-FOPD^{μ} controller is 50.02 Hz, which is much less than the frequency overshoots of the other controllers under discussion.

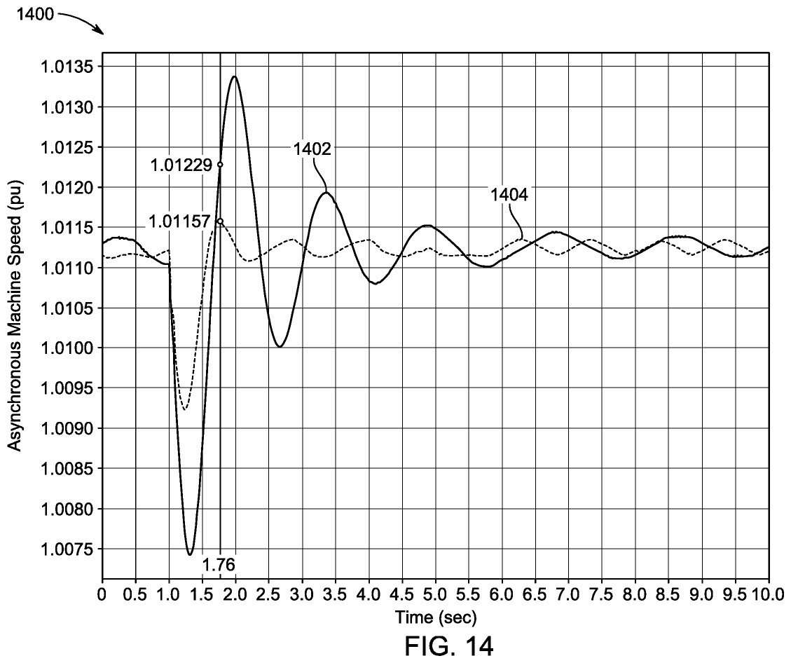

FIG. 14 shows a graphical representation 1400 of ASM speed (pu) of F-FOPD^{μ} controller and FOPD^{μ} controller, according to aspects of the present disclosure. In the example shown in FIG. 14, the ASM speed of the FOPD^{μ} controller, as depicted by curve 1402, plunged down to approximately 1.0075 pu from 1.011 pu and returned to 1.033 pu. The ASM speed of the F-FOPD^{μ} controller, as depicted by curve 1404, plunged down to approximately 1.0094 pu from 1.011 pu and returned to 1.012 pu after the frequency returned to 50 Hz.

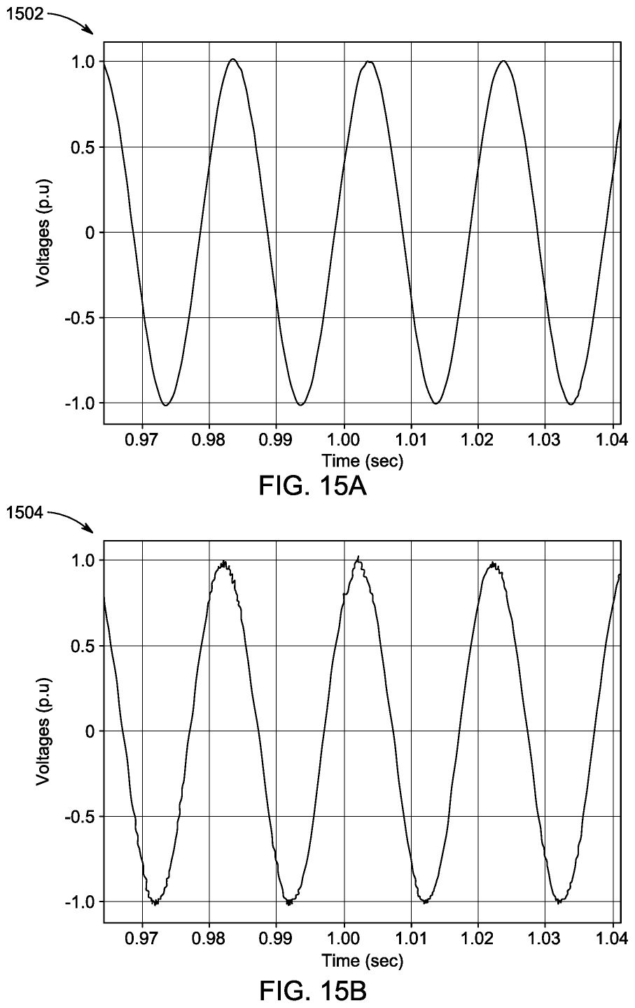

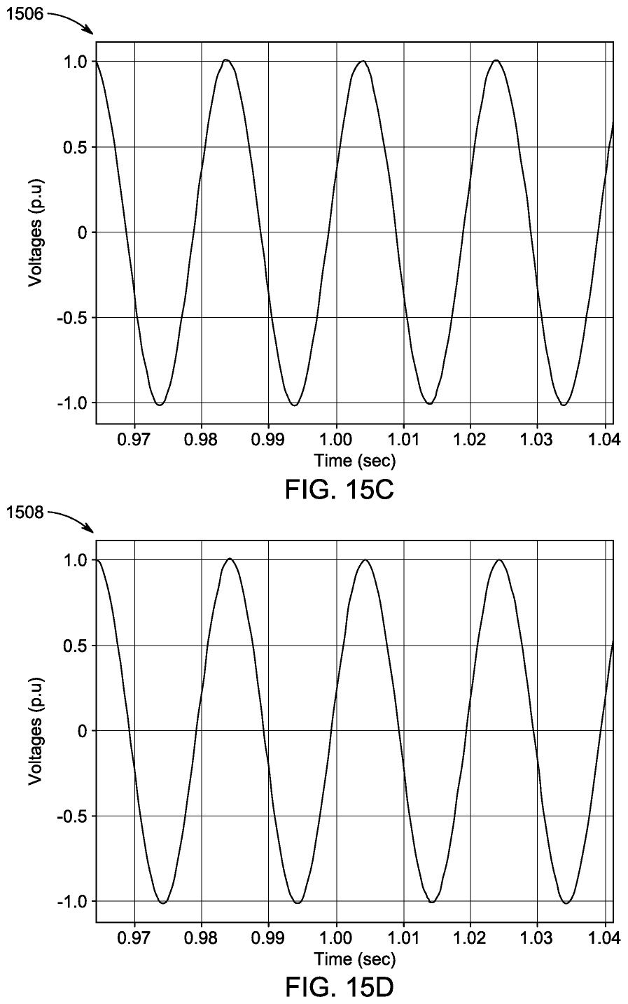

FIGS. 15A, 15B, 15C, and 15D illustrate graphical representations of voltages in per unit (pu) for a PD controller, a FOPD^{μ} controller, a F-PD controller, and a F-FOPD^{μ} controller. The graph is plotted against voltages (pu) with respect to time (sec). As required, the voltage retains at 1 pu without any oscillations. In particular, FIG. 15A shows a graphical representation 1502 of voltages in pu for the PD controller. FIG. 15B shows a graphical representation 1504 of voltages in pu for the FOPD^{μ} controller. FIG. 15C shows a graphical representation 1506 of voltages in pu for the F-PD controller. FIG. 15D shows a graphical representation 1508 of voltages in pu for the F-FOPD^{μ} controller.

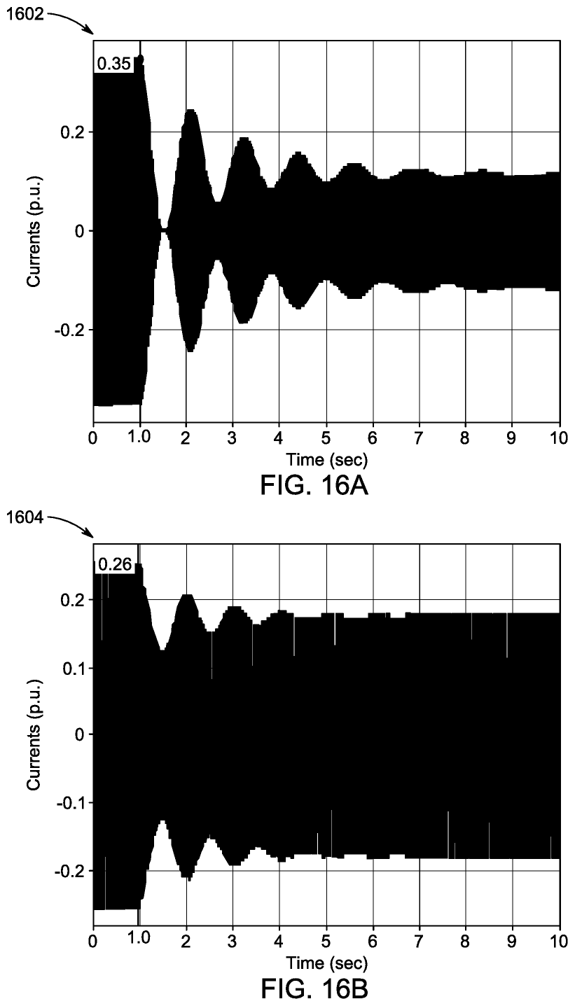

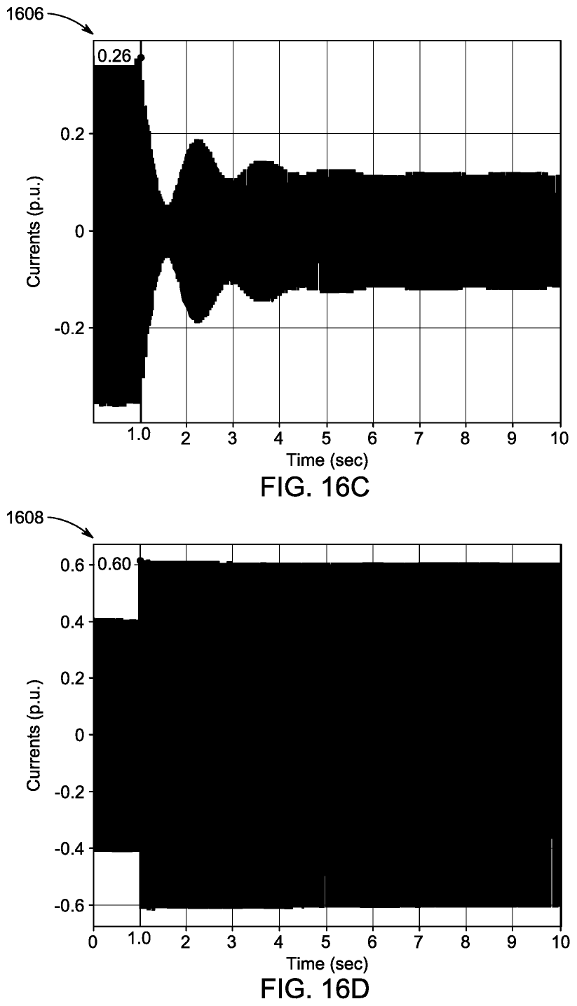

FIGS. 16A-16D show graphical representations of current in pu fed to the secondary load. In particular, FIG. 16A shows a graphical representation 1602 illustrating output currents in pu of the PD controller. FIG. 16B shows a graphical representation 1604 illustrating output currents in pu of the FOPD^{μ} controller. FIG. 16C shows a graphical representation 1606 illustrating output currents in pu of the F-PD controller. FIG. 16D shows a graphical representation 1608 illustrating output currents in pu of the F-FOPD^{μ} controller. The added load also impacts secondary load current which increases from 0.4 pu to 0.6 pu in steady state.

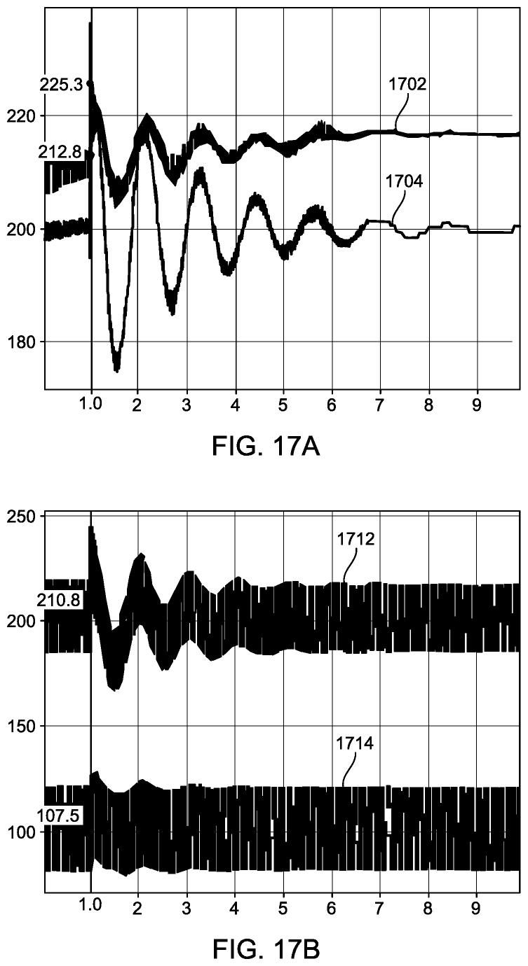

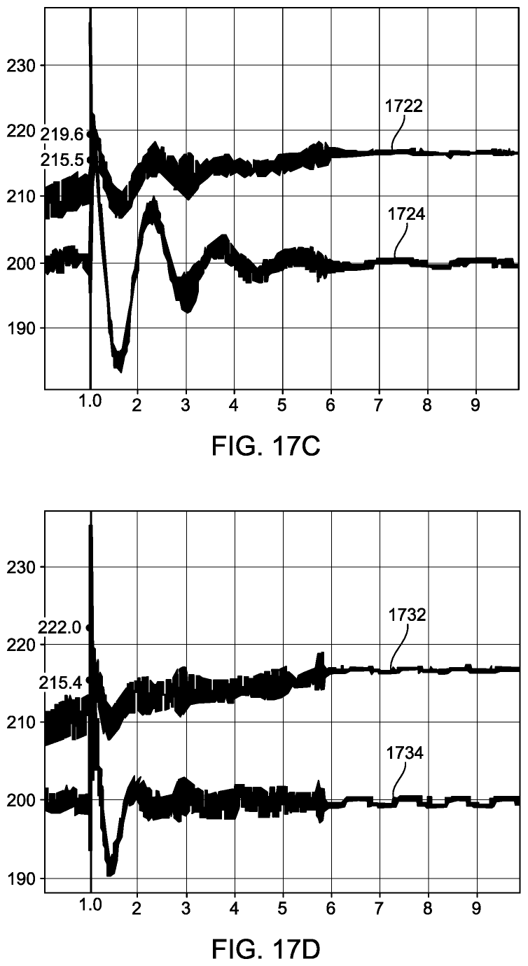

FIGS. 17A-17D show graphical representations of active power (kW) from the wind energy module 124 and reactive power (kvar) from ASM. FIG. 17A shows a curve 1702 representing reactive power (kvar) from ASM for the PD controller, and a curve 1704 representing active power (kW) from the wind energy module 124 for the PD controller. FIG. 17B shows a curve 1712 representing reactive power (kvar) from ASM for the FOPD^{μ} controller, and a curve 1714 representing active power (kW) from the wind energy module 124 for the FOPD^{μ} controller. FIG. 17C shows a curve 1722 representing reactive power (kvar) from ASM for the F-PD controller, and a curve 1724 representing active power (kW) from the wind energy module 124 for the F-PD controller. FIG. 17D shows a curve 1732 representing reactive power (kvar) from ASM for the F-FOPD^{μ} controller, and a curve 1734 representing active power (kW) from the wind energy module 124 for the F-FOPD^{μ} controller.

The total load in the system is 457 kW out of which 100 KW is the fixed load whereas the remaining 357 kW is the secondary load (138, 338). As soon as the added 50 kW consumer load 346 is turned on, the power absorbed by the secondary load (138, 338) slowly plunged down to regain the frequency to its supposed value. The power from the wind energy module 124 increases up to approximately 238 kW from 200 kW and then falls to approximately 191 kW before becoming stable at 200 kW within the interval of 1 second. The synchronous condenser reactive power increases up to approximately 10 kVar when load increment goes to 220 kVar from 210 kVar and finally come back to 216 kVar once the hybrid system 100 stabilizes.

Three-phase fault was applied near 50 kW load followed by instant opening of a circuit breaker (CB) operated by current relay. The current relay monitors the current, and if exceeds 10 kA, it opens the CB. The different quantities were observed for 1 second before fault occurrence and nine cycles after clearance of fault and monitored behavior of system.

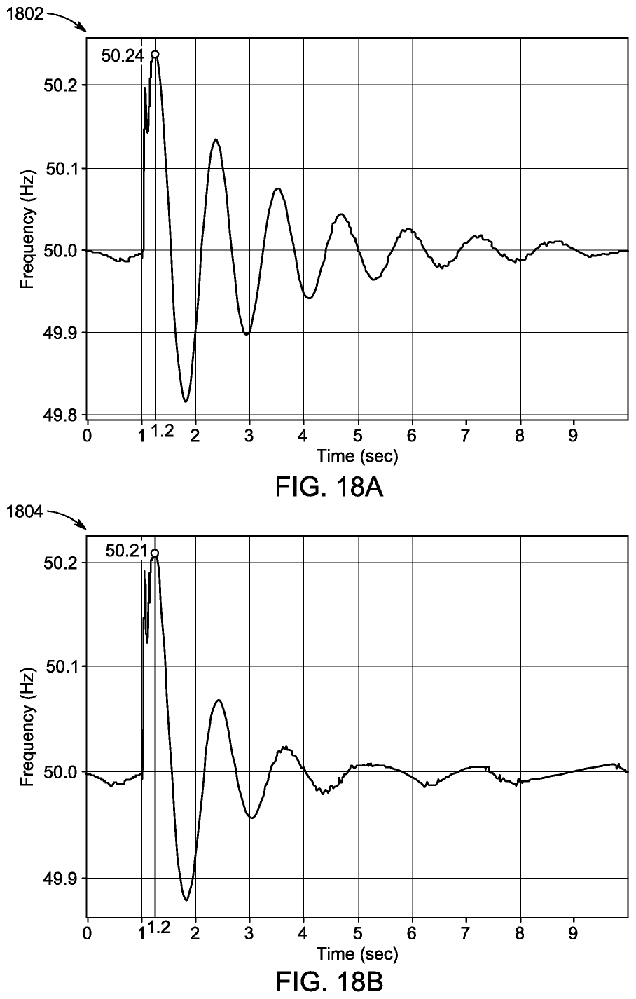

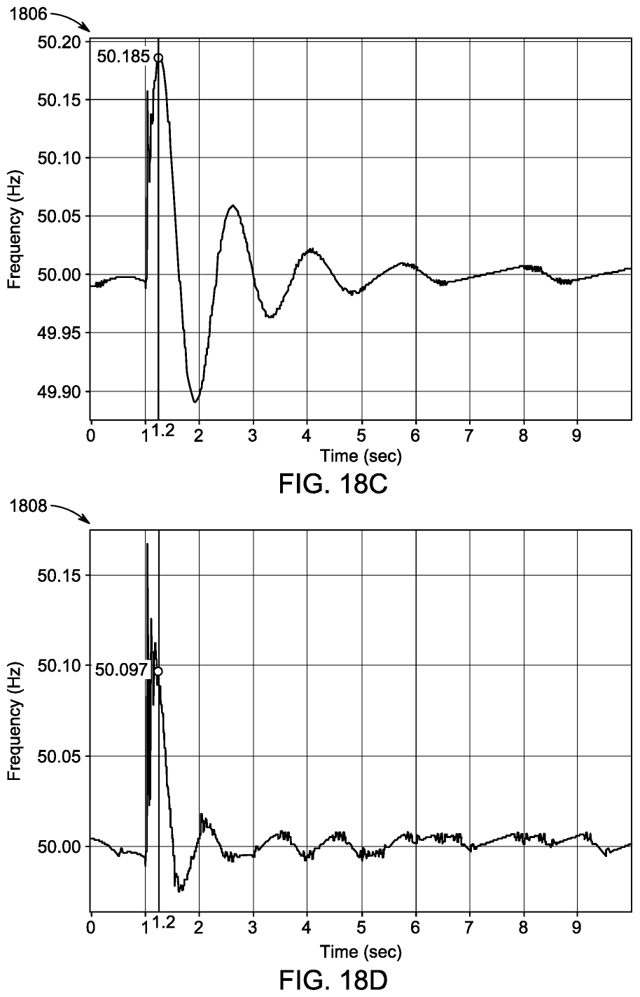

FIG. 18A-FIG. 18D show graphical representations of frequency responses of the PD controller, the FOPD^{μ} controller, the F-PD controller, and the F-FOPD^{μ} controller with 50 KW load decrement at 1 second. The frequency response gives an indication of the fault levels and level of contribution of fault current may add to the existing levels of current in case of faulty conditions.

FIG. 18A shows a graphical representation 1802 illustrating a frequency response of the PD controller with 50 KW load decrement, according to aspects of the present disclosure. FIG. 18B shows a graphical representation 1804 illustrating a frequency response of the FOPD^{μ} controller with 50 KW load decrement, according to aspects of the present disclosure. FIG. 18C shows a graphical representation 1806 illustrating a frequency response of the F-PD controller with 50 KW load decrement, according to aspects of the present disclosure. FIG. 18D shows a graphical representation 1808 illustrating a frequency response of the F-FOPD^{μ} controller with 50 KW load decrement, according to aspects of the present disclosure.

It can be observed that the frequency overshoot and recovery of the F-FOPD^{μ} controller is better than the other three controllers. The result displays very small jaunts of frequency that dampens down very fast and efficiently. The obtained response will clearly highlight the robustness of the four controllers and the performance of the F-FOPD^{μ} controller compared to other controllers.

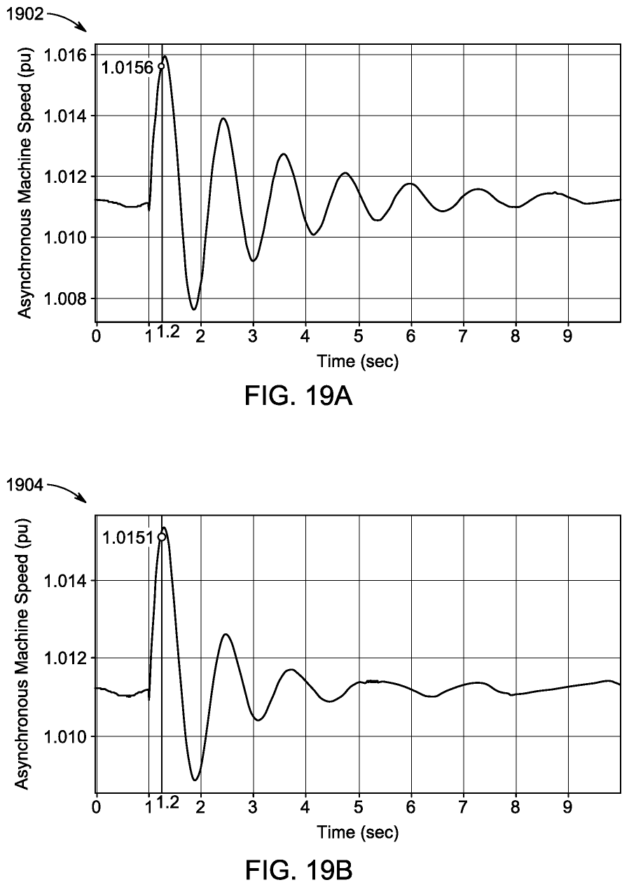

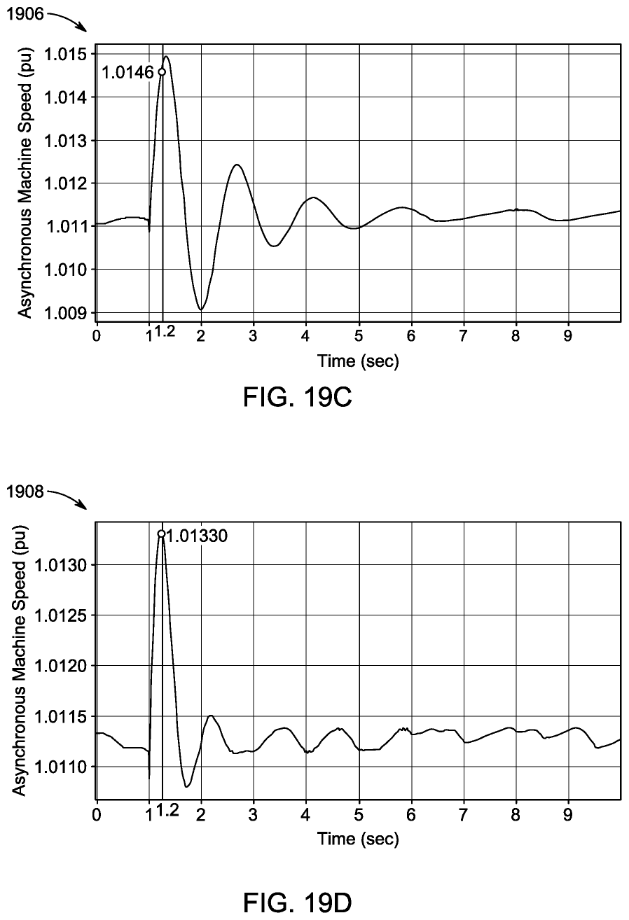

FIG. 19A-FIG. 19D show graphical representations of ASM speed recovery after the fault. The response comparison in ASM speed, in per unit (pu), of the four controllers is illustrated in FIGS. 19A-19D. FIG. 19A shows a graphical representation 1902 illustrating ASM speed in pu with respect to time in seconds for the PD controller. FIG. 19B shows a graphical representation 1904 illustrating ASM speed in pu with respect to time in seconds for the FOPD^{μ} controller. FIG. 19C shows a graphical representation 1906 illustrating ASM speed in pu with respect to time in seconds for the F-PD controller. FIG. 19D shows a graphical representation 1908 illustrating ASM speed in pu with respect to time in seconds for the F-FOPD^{μ} controller.

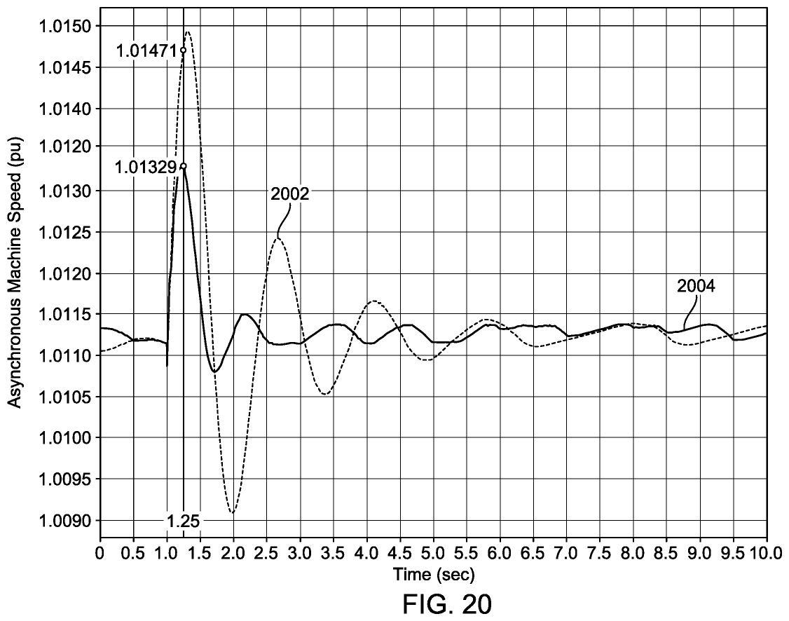

FIG. 20 shows a graphical representation illustrating the ASM speed of the FOPD^{μ} controller by curve 2002 and the F-FOPD^{μ} controller by curve 2004.

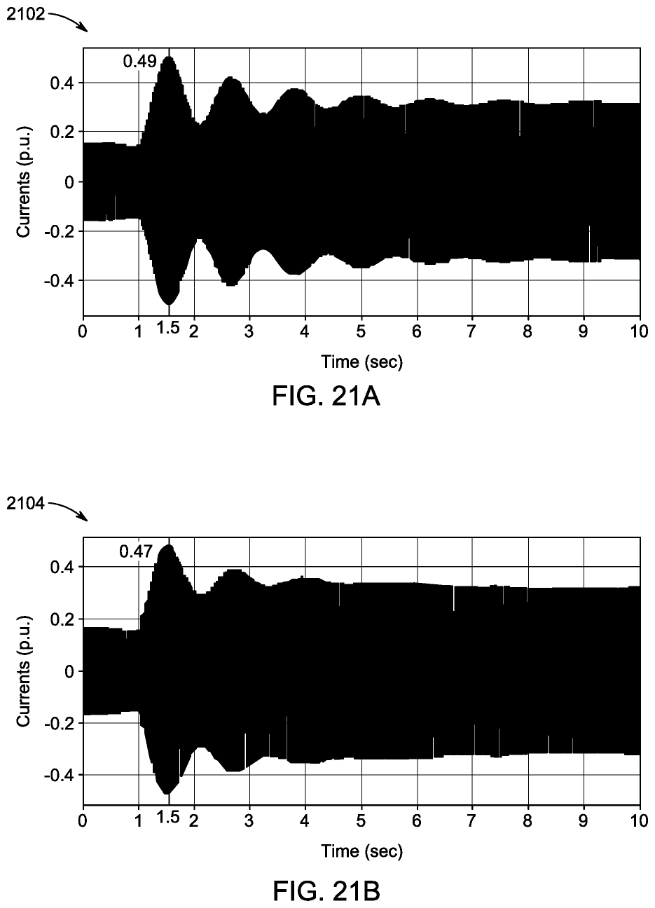

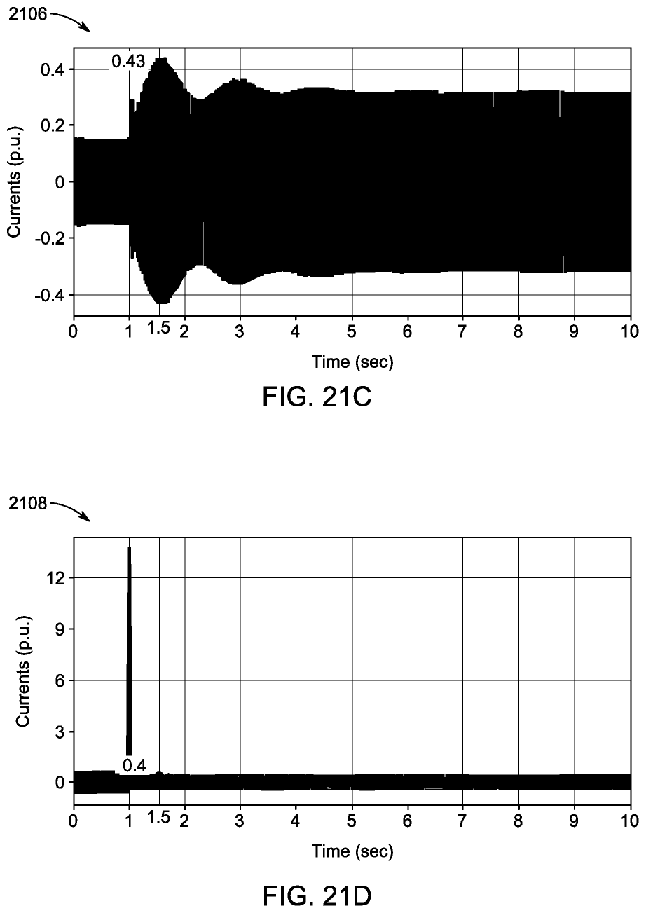

FIG. 21A-FIG. 21D show graphical representations of currents in per unit (pu) fed to the secondary load by four controllers. FIG. 21A shows a graphical representation 2102 illustrating current in pu fed to the secondary load by the PD controller. FIG. 21B shows a graphical representation 2104 illustrating current in pu fed to the secondary load by the FOPD^{μ} controller. FIG. 21C shows a graphical representation 2106 illustrating current in pu fed to the secondary load by the F-PD controller. FIG. 21D shows a graphical representation 2108 illustrating current in pu fed to the secondary load by the F-FOPD^{μ} controller. It is evident from the figures that voltages run smoothly like pre-disturbance values. The currents however adjust to new stable values so that the decrease in the power demand can be adjusted without voltage fluctuations.

Based on the experimental analysis, the fault current of 10 kA flows through the circuit breaker during the three-phase fault. The circuit breaker is designed based on ampere rating. The ampere rating is the maximum level of continuous current the circuit breaker can withstand. Based on the simulations it was observed that around 10 kA current flows for 50 kW load whereas around 25 kA flows for 75 kW load. The relay operates as the fault current exceeds 10 kA.

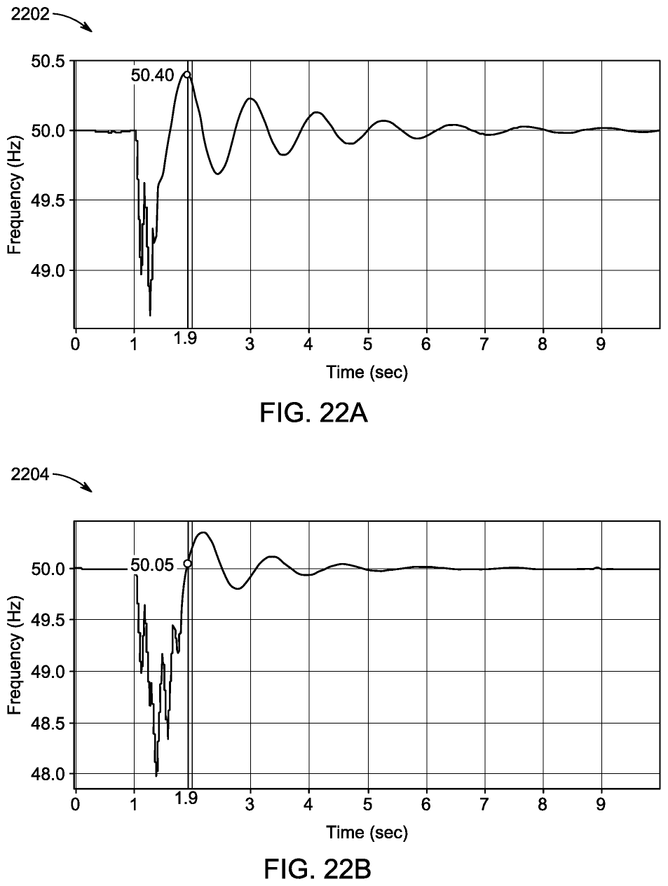

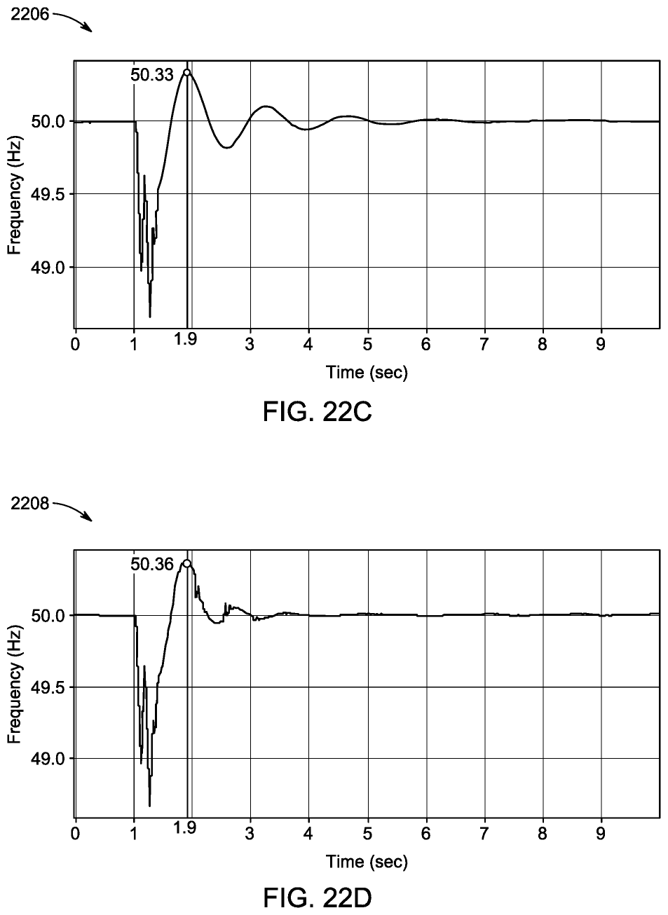

FIG. 22A-FIG. 22D show graphical representations of frequency responses for fault analysis. FIG. 22A shows a graphical representation 2202 illustrating a frequency response of the PD controller for fault analysis. FIG. 22B shows a graphical representation 2204 illustrating a frequency response of the FOPD^{μ} controller for fault analysis. FIG. 22C shows a graphical representation 2206 illustrating a frequency response of the F-PD controller for fault analysis. FIG. 22D shows a graphical representation 2208 illustrating a frequency response of the F-FOPD^{μ} controller. The three-phase faults is selected because it is generally considered the most harmful of all symmetrical faults, and all the protective equipment and switch gear are designed based on the short circuit current levels during these faults. The hybrid system 100 comes back to its steady state values after 5 cycles with complete tripping of a circuit emanating towards the load. The fault is considered in the closest vicinity load i.e., right at the load bus bar of 50 kW, cleared in 5 cycles i.e., 100 msec, as normal clearing time because the circuit breaker does not operate instantaneously but with the delay of 5 cycles.

$$50 Hz = 1 cycle \qquad ( 18 )$$

$$1 cycle = 1 / 50 Hz sec \qquad ( 19 )$$

$$5 cycle = 1 / 50 \times 5 = 0.1 sec \qquad ( 20 )$$

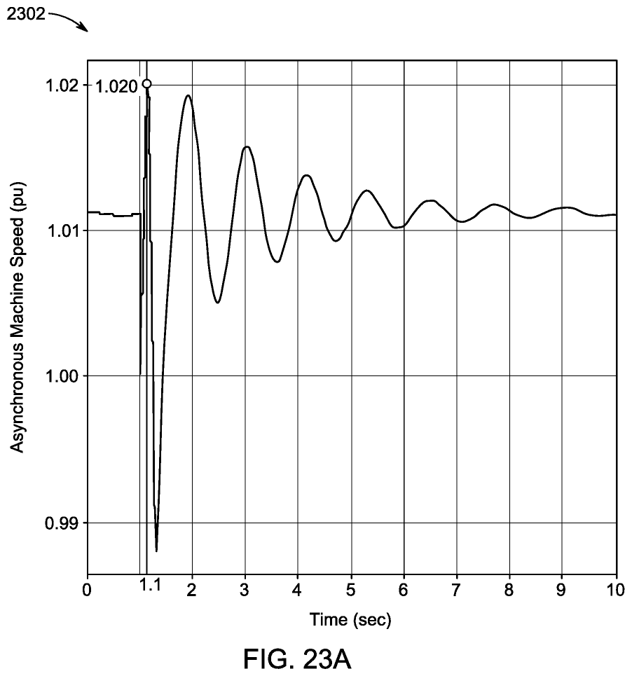

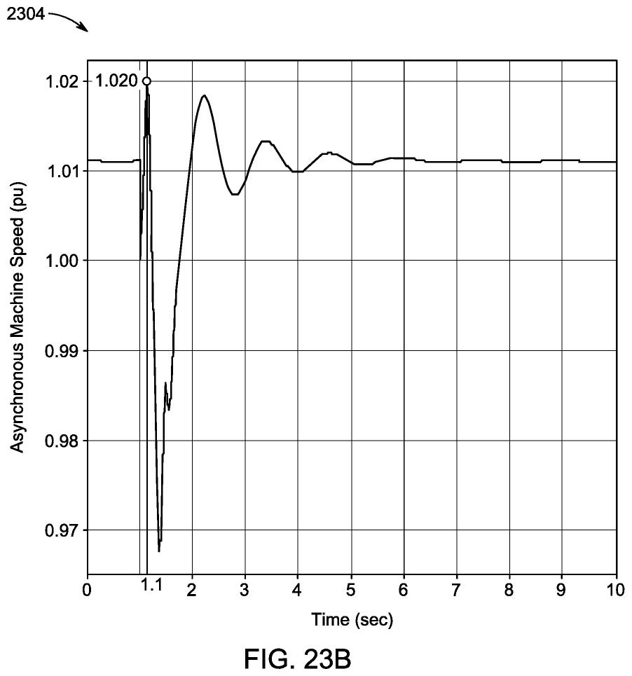

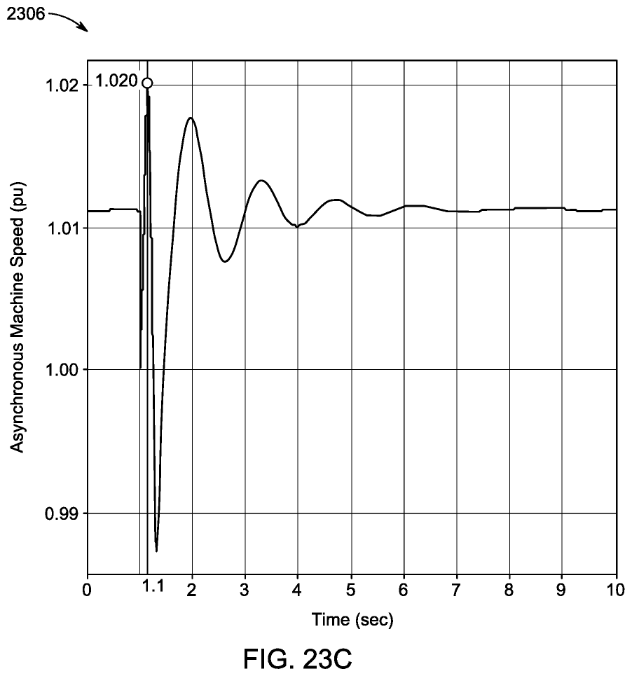

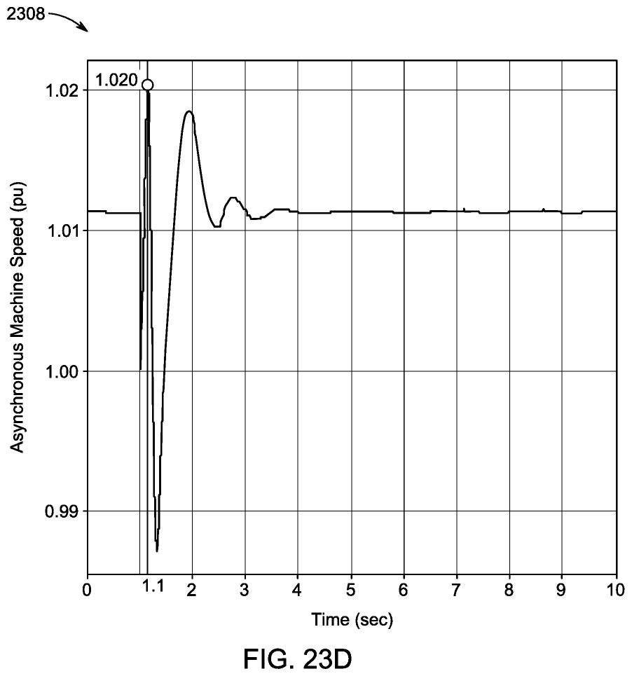

FIG. 23A-FIG. 23D show graphical representations of speed of recovery of ASM for four controllers after clearing of fault in 5 cycles. Results plotted in FIG. 22A-FIG. 22D show very small jaunts of frequency that dampens down very fast and efficiently after the clearing of fault. FIG. 23A shows a graphical representation 2302 illustrating recovery speed of ASM of the PD controller. FIG. 23B shows a graphical representation 2304 illustrating recovery speed of ASM of the FOPD^{μ} controller. FIG. 23C shows a graphical representation 2306 illustrating recovery speed of ASM of the F-PD controller. FIG. 23D shows a graphical representation 2308 illustrating recovery speed of ASM of the F-FOPD^{μ} controller.

It is evident from FIG. 12A to FIG. 23D, that the F-FOPD^{μ} controller is robust to prevent the frequency of the hybrid system 100 from collapsing even with the delay in circuit breaker (CB) opening. A circuit breaker is an automatic electric switch designed to protect an electrical circuit from damage caused by an overload or a short circuit.

The performance of the PD controller, the F-PD controller, the FOPD^{μ} controller, and the F-FOPD^{μ} controller, as depicted through FIG. 12A to FIG. 23D, under varying load disturbances are compared herein. Two frequency disturbance scenarios of load increment and load decrement of 50 KW was applied to access the controllers' performance. Settling time (at 0.05%), overshoot and integral of the absolute error (IAE), integral of the squared error (ISE), and integral of time multiplied into the absolute error (ITAE) were the parameters that were considered as measure of the controller's performance. The values of these parameters, for the four controllers, are given in Table 3 and Table 4. The performance trials given as:

$$IAE = \int \vert e ( t ) \vert dt \qquad ( 21 )$$

$$ISE = \int {e}^{2} ( t ) dt \qquad ( 22 )$$

$$ITAE = \int t \vert e ( t ) \vert dt \qquad ( 23 )$$

where “e” stands for the error in frequency (Hz) and “t” stands for time taken in seconds.

TABLE 3
Performance analysis of different controllers
with 50 kW load increment

| Controller | ITAE | IAE | ISE |
|---|---|---|---|
| F-FOPD^{μ} | 0.1333 | 0.1523 | 0.01961 |
| FOPD^{μ} | 0.8695 | 0.5536 | 0.08985 |
| F-PD | 0.5933 | 0.5738 | 0.1752 |
| PD | 2.061 | 0.966 | 0.1778 |

TABLE 4
Performance analysis of different controllers
with 50 kW load decrement

| Controller | ITAE | IAE | ISE |
|---|---|---|---|
| F-FOPD^{μ} | 0.09589 | 0.1114 | 0.01096 |
| FOPD^{μ} | 0.6661 | 0.3903 | 0.04105 |
| F-PD | 0.6088 | 0.3718 | 0.04149 |
| PD | 1.563 | 0.6931 | 0.08216 |

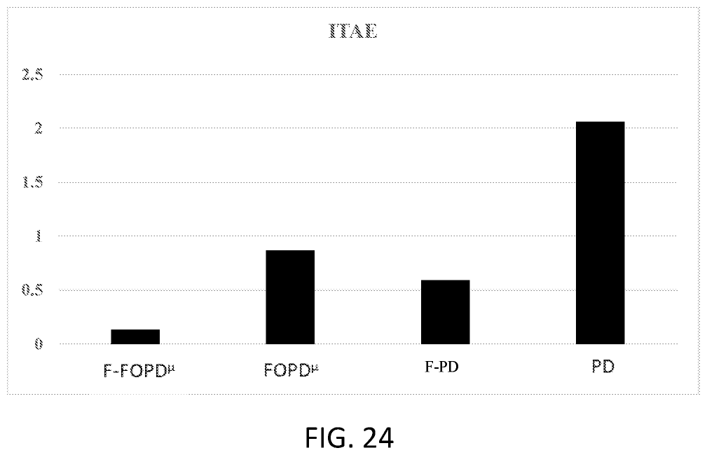

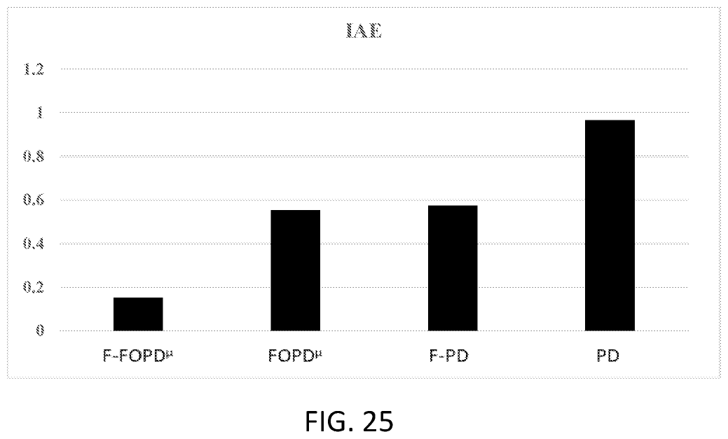

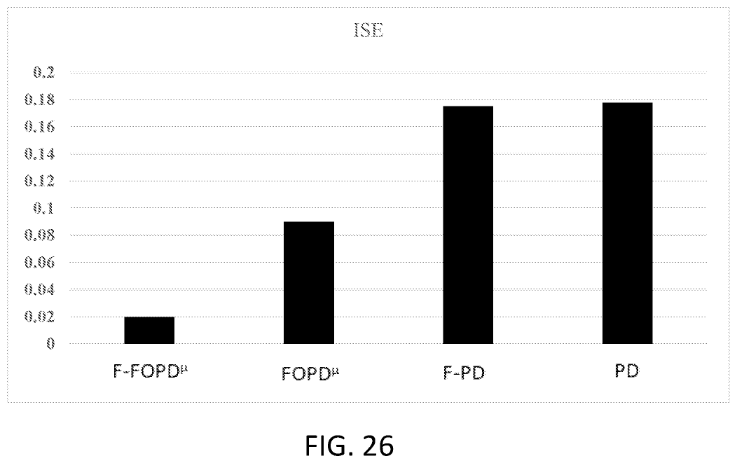

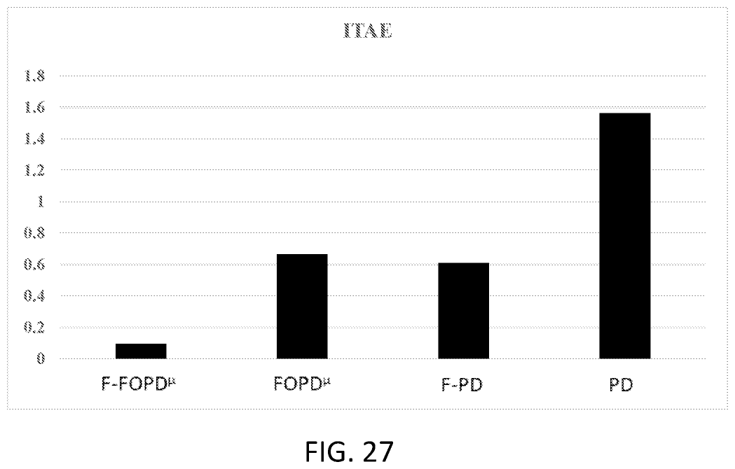

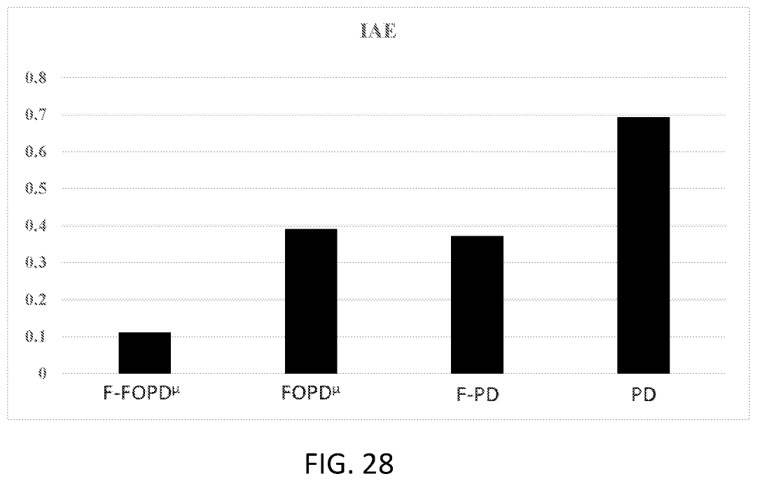

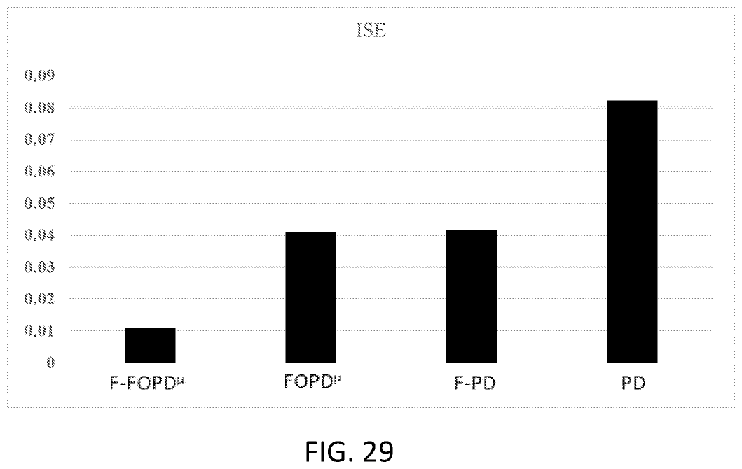

It can be seen in Table 3 that the controller F-FOPD^{μ} results in lower values for ITAE, IAE and ISE which is 0.1333, 0.1523 and 0.01961 respectively which is lower compared to the results of all the other controllers. This is further shown in bar charts in FIG. 24, FIG. 25, and FIG. 26. The controller F-FOPD^{μ} also shows strength and better execution by having smaller performance measures like ITAE, IAE and ISE in load shedding scenario as can be seen in Table 4, given as 0.09589, 0.1114 and 0.01096, respectively. This is further shown in bar charts in FIG. 27, FIG. 28, and FIG. 29. The simulation results show that discrete time F-FOPD^{μ} controller demonstrates better performance in frequency control in comparison to the remaining three controllers in all settings. Furthermore, it is the most robust among all since it exhibits higher performance in all the performance measures considered.

The various embodiments and the aspects of the present disclosure relate to the hybrid system 100 with the F-FOPDμ controller. The F-FOPDμ controller is implemented for effective load frequency control under various load conditions. The F-FOPDμ controller automatically adjusts the gains using fuzzy logic to maintain optimal performance of the hybrid system 100. As described earlier, a diesel generator (DG) operates without consuming power, functioning as a synchronous condenser. The DG supports the wind energy system by ensuring a stable voltage and balancing reactive power, crucial for automatic generation control.

The robustness of the hybrid system 100 was tested under different challenges, including variable system parameters, fluctuating loads, and three-phase symmetrical faults. In the latter scenario, a delayed response of the circuit breaker (CB) by 5 cycles was also considered. One of the features of the F-FOPDμ controller is the ability to optimize the performance of the hybrid system 100 and reduce transient disturbances effectively. In situations where excess power is generated, a secondary load steps in to absorb the extra energy, ensuring system stability.

The control strategy is meticulously designed to nullify frequency errors, ensuring a stable and efficient operation even under dynamic load changes. Frequency oscillations are minimized, and the hybrid system 100 achieves minimal steady-state error, displaying the effectiveness and reliability of the F-FOPDμ controller. Further, variations in frequency resulting from disturbances within the hybrid system 100 are minimized. Implementation of the F-FOPDμ controller improves load frequency control, highlighting its superiority over the PD controller, the F-PD controller, and the FOPDμ controller. The discrete frequency control system serves dual roles, managing secondary load and ensuring load frequency control. The hybrid system 100 as disclosed adheres to the IEEE standard that requires the frequency to be maintained within a ±0.5 Hz range for a 50 Hz power system.

1. A distributed control system coupled to a hybrid renewable power system including an AC power section, a DC power section, and a primary load comprising:
a current-controlled inverter configured to control a flow of power between the DC power section and the AC power section using a pair of power flow control signals, wherein the current-controlled inverter comprises a proportional-integral controller configured to generate the pair of power flow control signals;
a discrete frequency controller configured to perform a load frequency control of the hybrid renewable power system using a pair of load frequency control signals, wherein the load frequency control is controlling one or more frequency oscillations of the primary load, wherein the discrete frequency controller is a discrete-time fuzzy tuned fractional-order proportional derivative controller; and
wherein the fuzzy tuned fractional-order proportional derivative controller is configured to generate the pair of load frequency control signals based on a primary load frequency, a desired load frequency, and a rate of change of the primary load frequency.

2. The distributed control system of claim 1, wherein the proportional integral controller is configured to generate the pair of power flow control signals based on the primary load frequency and a pre-determined average frequency of the primary load.

3. The distributed control system of claim 1, wherein the proportional-integral controller is coupled to a bidirectional insulated gate bipolar transistor (IGBT) of the hybrid renewable power system.

4. The distributed control system of claim 3, wherein the bidirectional insulated gate bipolar transistor (IGBT) is configured to perform either inversion of power from DC to AC or rectification of power from AC to DC.

5. The distributed control system of claim 1, wherein the discrete frequency controller is coupled to a secondary load.

6. The distributed control system of claim 5, wherein the discrete frequency controller is further configured to transfer an excess power generated in the AC power section to the secondary load.

7. The discrete frequency controller of claim 5, wherein a plurality of gate turn-off thyristors are connected between the discrete frequency controller and the secondary load.

8. The distributed control system of claim 5, wherein the secondary load comprises a plurality of 8-bit 3-phase resistors and a plurality of switches.

9. The distributed control system of claim 1, wherein the primary load is connected to the AC power section of the hybrid renewable power system.

10. The distributed control system of claim 1, wherein the DC power section of the hybrid renewable power system comprising:
a plurality of DC renewable power modules configured to generate a DC power; and
a plurality of DC-DC converters coupled to the plurality of DC renewable power modules.

11. The distributed control system of claim 10, wherein the plurality of DC renewable power modules includes a photovoltaic module, a fuel cell module, and a battery energy storage module.

12. The distributed control system of claim 1, wherein the AC power section of the hybrid renewable power system comprising a wind energy module configured to generate a wind power.

13. The distributed control system of claim 12, wherein the wind energy module comprises a wind turbine and an induction generator.

14. The distributed control system of claim 12, wherein a diesel generator is coupled to the wind energy module.

15. The distributed control system of claim 14, wherein a voltage exciter is connected to the diesel generator to balance out voltages of the distributed control system and the hybrid renewable power system.

16. The distributed control system of claim 14, wherein the diesel generator is a synchronous machine with a zero input and zero output.

17. The distributed control system of claim 1, wherein the fuzzy tuned fractional-order proportional derivative controller is configured to perform fuzzification using the primary load frequency, the desired load frequency, and the rate of change of the primary load frequency to generate a fuzzy value.

18. The distributed control system of claim 17, wherein the fuzzy tuned fractional-order proportional derivative controller is further configured to perform defuzzification through an inference mechanism to generate the pair of load frequency control signals from the fuzzy value.

19. The distributed control system of claim 1, wherein the distributed control system is configured to return to steady-state from up to 5 delay cycles in circuit breaker operations.

20. The distributed control system of claim 1, wherein the distributed control system is configured to operate in time domain.
